(19) United States
(12) Patent Application Publication
(10) Pub. No.: US 2007/0245033 A1
(43) Pub. Date: Oct. 18, 2007

(54) Link layer discovery and diagnostics

(75) Inventors: Alexandru Gavrilescu, Redmond, WA (US); Alvin K. Tan, Redmond, WA (US); Austin N. Donnelly, Cambridge (GB); Chong Zhang, Bellevue, WA (US); Glen R. Ward, Seattle, WA (US); Richard John Black, Cambridge (GB)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/405,002

(22) Filed: Apr. 14, 2006

(51) Int. Cl. G06F 15/16

(52) U.S. Cl. 709/230

(57) ABSTRACT

Described is a technology including an Ethernet layer 2 protocol by which a node of a computer network can discover information about other network computing elements, including discovering network topology information, and/or collecting diagnostic information. The protocol allows multiple responders to communicate data with a mapper node for topology discovery, with one or more enumerator nodes for quick enumeration, or with a controller node for network tests that collect diagnostic information. The responders process the received data to determine the type of service (quick discovery, topology discovery or network test) and the service type's related function, and take action based on these and possibly additional criteria in the data. Actions may include responding to the data, following received commands, collecting statistics, responding to queries, and so forth.

### BACKGROUND

Network topology discovery is the practice of mapping a network to discover a graph representing the interconnections between hosts and various pieces of network infrastructure, such as hubs, switches, and routers. The graph may be annotated with various link properties, e.g., bandwidth, delay, and loss rate. Network topology discovery can be at a variety of levels ranging from Internet-scale mapping efforts to small-scale home area networks.

With respect to home area networks and the like, various home and small business computer users are using wired and wireless routers, switches, hubs and other relatively low priced components to implement small computer networks. Devices are also coming available that allow network communications to be carried over regular electrical wiring. Home area networks provide no support, or at best minimal support, for network topology discovery.

Various technologies are generally directed towards network topology discovery in networks. One such technology accomplishes network topology discovery including in home area networks by having various training and probing packets sent from one node to other nodes in the network, through interconnection elements. Based on how switches are trained and the response information that is returned to the sending node, the sending node is able to map the network topology, e.g., with respect to how routers, switches and hubs interconnect the nodes.

While this works extremely well in testing, it is not straightforward to implement, and thus home area network users have yet to benefit from this technology. Topology discovery, as well as diagnostics, are desirable as valuable tools for users of small networks. However, at present, only large managed networks have such capabilities.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards communicating data over a network discovery and/diagnostics protocol, including in one aspect broadcasting a discovery or network test request from a computing node to a plurality of responders. Via the protocol, commands are sent from a mapper-type network station to cause at least some of the responders to obtain and/or return network topology-related data, or from a collector-type network station to cause at least some of the responders to collect and return network diagnostics data.

The protocol allows multiple responders to communicate with one or more enumerator nodes for quick enumeration, as well as with the mapper node for topology discovery, or the controller node for network tests that collect diagnostic information. The responders process the received data (frames from the network station) to determine the type of service (quick discovery, topology discovery or network test) and the service type's related function, and take action based on these and possibly additional criteria in the data. Actions may include responding to the data, following received commands, collecting statistics, responding to queries, and so forth.

Other advantages will become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment into which various aspects of the present invention may be incorporated.

FIG. 2 is a block diagram representing an example network in which nodes and interconnection elements communicate to discover network topology and/or acquire diagnostics-related information.

FIG. 3 is a block diagram representing an example computing element communicating with one or more responder computing elements to discover network topology and/or acquire diagnostics-related information.

FIG. 4 is an example header hierarchy used in a network topology discovery/diagnostics protocol.

FIG. 5 represents one suitable example configuration for a demultiplex header format used in a network topology discovery/diagnostics protocol.

FIG. 6 exemplifies a suitable base header format used in a network topology discovery/diagnostics protocol.

FIG. 7 is a representation of an example base header format is shown in one configuration used in a network topology discovery/diagnostics protocol that is suitable for topology discovery, emit and/or network test communications.

FIG. 8 is a representation of an enumeration state engine used in network topology discovery/diagnostics, and that operates in various states including a quiescent state a pausing state and a wait state.

FIG. 9 is a representation of a session state engine comprising a dynamic table referred to as a session table used in network topology discovery/diagnostics.

FIG. 10 is a representation of a topology discovery state engine used in network topology discovery/diagnostics that operates in various states including a quiescent state, a command state and an emit state.

FIG. 11 is a representation of an example discover header that follows the base header, and that is used in a network topology discovery/diagnostics protocol

FIG. 12 is a representation of an example station list used in a network topology discovery/diagnostics protocol.

FIG. 13 is a representation of an example Hello data structure used in a network topology discovery/diagnostics protocol.

FIG. 14 is an example of a (type-length-value) entry used in a network topology discovery/diagnostics protocol.

FIG. 15 is a representation of an example End-Of-Property list marker that marks the end of the TLV list and exists in a Hello frame.

FIG. 16 is a representation of an example Host ID property that provides a way to uniquely identify the host on which a responder is running.

FIG. 17 is a representation of an example characteristics property that allows a responder to report various simple characteristics of its host or the network interface it is using.

FIG. 18 represents an example physical medium property that allows a responder to report the physical medium type of the network interface it is using.

FIG. 19 represents an example wireless mode property that allows a responder to identify how its IEEE 802.11 interface connects to the network.

FIG. 20 is a representation of an example BSSID (Basic Service Set Identifier in IEEE 802.11 wireless networking) property that allows a responder to identify the media access control (MAC) address of the access point with which its wireless interface is associated.

FIG. 21 is a representation of an example 802.11 SSID property that allows a responder to identify the service set identifier (SSID) of the BSS with which its wireless interface is associated.

FIG. 22 is a representation of an example IPv4 Address property that allows a responder to report its most relevant IPv4 address, if available.

FIG. 23 is a representation of an example IPv6 Address property that allows a responder to report its most relevant IPv6 address.

FIG. 24 represents a data structure for containing a maximum data rate at which a radio can run on its 802.11 interface.

FIG. 25 represents an example data structure for a performance counter frequency property that allows a responder to identify how fast its timestamp counters run.

FIG. 26 represents a link speed property data structure that allows a responder to report the maximum speed of its network interface.

FIG. 27 represents an example 802.11 RSSI property that allows a responder to identify the IEEE 802.11 interfaces' received signal strength indication (RSSI).

FIG. 28 is a representation of an example icon image property that may contain an icon image representing a host running the responder.

FIG. 29 is a representation of an example machine name property that may contain the device's host name.

FIG. 30 is a representation of an example support information property that may contain a device manufacturer's support information

FIG. 31 is a representation of an example property that may contain a friendly name or description assigned to the computer.

FIG. 32 is a representation of an example device UUID (Universally Unique Identifier) property, which returns the UUID of a device that supports Universal Plug-and-Play.

FIG. 33 is a representation of an example hardware ID property that may comprise the string used by PnP to match a device with an INF file contained on a Windows®-based personal computer.

FIG. 34 is a representation of an example QoS Characteristics property that allows a responder to report various QoS-related characteristics of its host or the network interface it is using.

FIG. 35 is a representation of an example 802.11 Physical Medium property that allows a responder to report the 802.11 physical medium in use.

FIG. 36 is a representation of an example AP association table property that may contain information useful for discovering legacy wireless devices that do not implement the responder code.

FIG. 37 is an example table entry format for the table of FIG. 36, including the MAC address of wireless host, and a maximum operational rate that describes the maximum data rate at which the selected radio can run to the given host.

FIG. 38 represents an example property that contains detailed icon image data suitable for relatively greater resolutions.

FIG. 39 is a representation of an example Sees-list Working Set property that allows a responder to report a maximum count of RecveeDesc entries that may be stored in its sees-list database.

FIGS. 40-42 are example representations of a component table, including a bridge component descriptor (FIG. 40), a wireless radio band component descriptor (FIG. 41) and a built-in switch component descriptor (FIG. 42).

FIG. 43 is an example of an Emit frame that is used in a network topology discovery/diagnostics protocol, and that includes a list of source and destination Ethernet addresses.

FIG. 44 is an example of a structure within an Emit frame that may contain emit-related items, used in a network topology discovery/diagnostics protocol, such as for training and probing.

FIG. 45 is a representation of an example response to a query including a field that identifies a count of RecveeDesc structures (as exemplified in FIG. 46) returned in a network topology discovery/diagnostics protocol.

FIG. 46 is an example RecveeDesc data structure that contains protocol type data such as related to probe or discovery.

FIG. 47 represents an example format of a flat frame including current transmit credit (CTC)-related data.

FIG. 48 is a representation of an example QueryLargeTlv request data structure that allows a mapper to query a responder for TLVs that are too large to fit into a single Hello frame.

FIG. 49 is a representation of an example A QueryLargeTlvResp frame that may contain a response to a QueryLargeTlv request (FIG. 48).

FIGS. 50 and 51 are representations of nodes interconnected in a network that changes over time, with the changes handled via Hello frames.

FIG. 52 comprises an example QosInitializeSink upper-level header format by which a QosInitializeSink frame is sent to the Sink to set up a network test session.

FIG. 53 is a representation of an example QosReady frame sent in reply to QosInitializeSink frame (FIG. 52) to confirm the creation or existence of a network test session.

FIG. 54 is a representation of an example QosProbe data structure for controller and sink data including timestamp data a timed probe test and a probegap test.

FIG. 55 is an example of a QosQueryResp data structure (following a base header) that contains information related to QosEventDesc items (FIG. 56).

FIG. 56 is a representation of an example QosEventDesc data structure containing QosEventDesc items referenced in the data structure of FIG. 55.

FIG. 57 is a representation of an example QosError data structure that may be returned, in which an error code field specifies an error code that identifies a reason why a request failed.

FIG. 58 is a representation of an example QosCounterSnapshot data structure including a history size field that indicates a number of items to return from the history.

FIG. 59 is a representation of an example QosCounterResult data structure, containing a sub-second span field that indicates a time span since the last sampling interval, and a snapshot list.

FIG. 60 is a representation of an example snapshot entry in the list contained in the data structure of FIG. 59.

### DETAILED DESCRIPTION

Exemplary Operating Environment

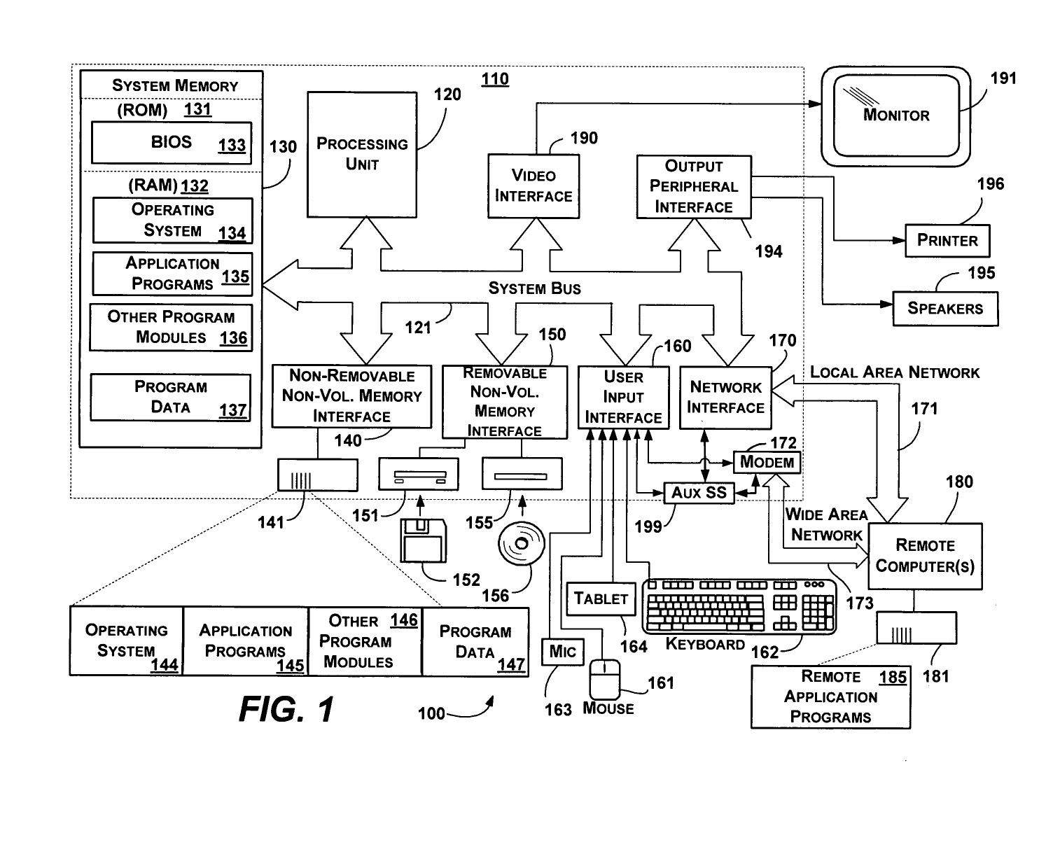

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, described above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

An auxiliary display subsystem 199 may be connected via the user interface 160 to allow data such as program content, system status and event notifications to be provided to the user, even if the main portions of the computer system are in a low power state. The auxiliary display subsystem 199 may be connected to the modem 172 and/or network interface 170 to allow communication between these systems while the main processing unit 120 is in a low power state.

Link Layer Discovery and Diagnostics

Various aspects of the technology described herein are directed towards a technology that provides network topology discovery and diagnostics that operates at a link layer of a local area network. In one aspect, the technology includes an example Link Layer Discovery and Diagnostics (LLD2) protocol that operates over Ethernet media. Note that LLD2 is a superset of an existing Link Layer Topology Discovery protocol, as generally related to U.S. patent application Ser. No. 10/768,582 filed Jan. 29, 2004, assigned to the assignee of the present invention and hereby incorporated by reference. That application generally describes various mechanisms for discovering the topology of an Ethernet network of computers and other elements, which is active, collaborative (of the computer systems), operates at the data-link layer, and does not require any support from the network elements. In general, using only the computer systems of a network, the significant detail of the network is obtained, that is, network topology information is thus provided which previously was unavailable.

In general, an example mechanism for discovering network topology utilizes one or more software components that are capable of collaboration with similar components incorporated on other computer systems attached to the network of interest. The components arrange to inject traffic into the network, and the components also observe the links on which they are connected to detect such injected traffic, whether injected by that computer system or one of the collaborating computer systems. The effect of the routing of the injected traffic by the network is that the traffic will pass over some links, will not pass over some links, and in some cases may be discarded by the network. The detection of the link or links over which the injected traffic passes, and the link or links over which the injected traffic does not pass, or the loss of the injected traffic within the network can be used to determine the organization of the network links. For example, the mechanism can discover not only the topology of those links of the network on which collaborative systems are directly connected, but can also infer the topology of other links on the network on which no such systems are directly connected.

In a first coordinated step, the computer systems put their network interfaces into the promiscuous mode, and train each of the switches in the entire network as to their location. Second, a particular computer system is selected to collect the information. Third, each other computer system sends a packet to the selected computer system and at the same time observes and records which packets it observes from the other computers also sent to the selected computer system. This is essentially a “probe” method that operates based on the fact that some other computer in the network can then send a packet to the source address used in the local training packet, and the system can observe which of the segment leaders receive the probe packet. Note that any switch other than the ones trained in the second step of the training phase will not know the trained address and so will copy the packet to segments other than the segment from which it came in. Fourth, each computer reports the source addresses of the packets that it was able to observe in the third step.

From the received packets, the selected computer constructs a “sees” matrix or the like, which can be used to determine if two computers are on the same segment, wherein a segment is a set of stations which see each others' packets, (which as described below may comprise frames). For example, a sees matrix records that computer A sees computer B if computer A was able to observe a packet from computer B to the selected computer. A general rule is that two computers are in the same segment only if both are capable of seeing the other, that is, when computer A sees computer B and also computer B sees computer A. This allows the segments (specifically those segments on which there is at least one computer) to be determined. The data manipulation methods used to make this determination from the sees matrix, as with other data manipulation methods and systems, are described below with reference to various processing methods and systems.

In one implementation, the LLD2 protocol is designed for a local area network, and in this implementation is not intended to be routed in a wide area network configuration; that is, the protocol is intended for a single IP subnet. As will be understood, the LLD2 protocol serves two primary purposes, namely network topology discovery and network test (diagnostics and/or probing). Notwithstanding, the technology described herein is not limited to the particular protocol, nor to any network configuration, and as such, is not limited to any particular examples used herein, but rather may be used various ways that provide benefits and advantages in computing and networking in general.

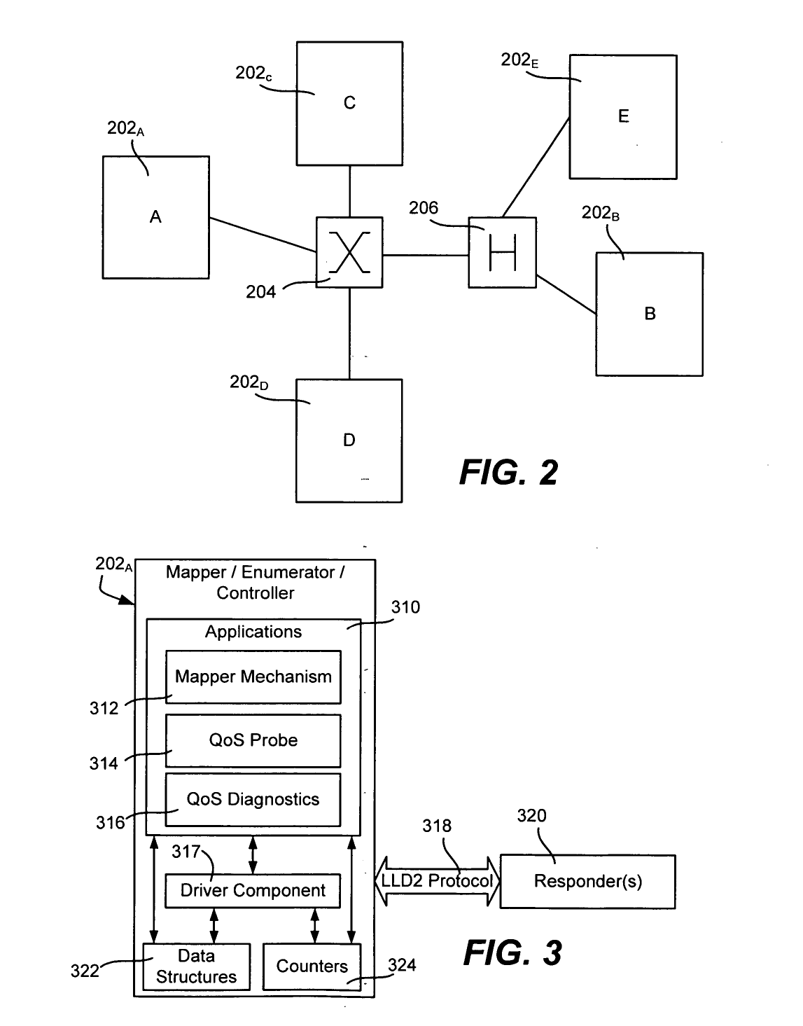

FIG. 2 represents an example local area network of nodes 202_{A}-202_{E} interconnected by interconnection elements exemplified as a switch 204 and a hub 206. As is understood, this is only one example local area network configuration, and there alternatively may be any practical number of nodes and interconnection elements including one or more bridges and routers in a given network. As can be readily appreciated, at least because of the extremely large number of possible ways to configure a network, having the nodes discover a current topology and/or perform diagnostics on network elements is highly valuable to computer network users.

In the example of FIG. 2, consider a station that wants to discover other stations as well as the interconnection elements, wherein in general, a “station” refers to any end-system that is connected to a switch, hub, or router. Note that any of the connections in a network may be wired over conventional Ethernet cables or the like, but also that wireless connections are well known, as are alternative connection technologies such as one that allows network communications to be sent over the wiring in a home or small business environment (sometimes referred to as powerline Ethernet). For example, one or more of the nodes (e.g., the node 202_{D}) may comprise a wireless access point (such as a wireless router), and in turn other network computing elements including stations may connect wirelessly to the node 202_{D}. As will be understood, the example protocol described herein handles wireless Ethernet and other (e.g., powerline) Ethernet communications in addition to networks connected via conventional Ethernet cables and the like.

FIG. 3 represents an example network element such as implemented in a station (e.g., the node 202_{A}) that comprises a computer system, (such as based on the computer 110 of FIG. 1). To enumerate, discover network topology and perform diagnostics, one node such as the node 202_{A} acts as an enumerator, mapper and/or controller, respectively, and includes application programs 310 such as including a mapper mechanism program 312, a QoS (quality of service) probe program 314 and a QoS diagnostics program 316. Note that as used herein, a “mapper” generally refers to an (arbitrary) station that initiates a topology discovery request, a “controller” generally refers to an (arbitrary) station that initiates a network test request, and an “enumerator” generally refers to an (arbitrary) station that participates in the node discovery process; a given station can act in any one, two or all three of these roles. In one example implementation, in general, a low-level driver component 317 provides packet send/receive functionality to the mapper, and provides network test session management capabilities, including packet send/receive functionality, to the QoS probe and QoS diagnostics features, (although as can be readily appreciated, separate drivers can be used to handle this aspect in alternative implementations). In one implementation, a mapper or controller needs to be selected, as provided for by the protocol, because only one may operate in a network at the same time. The protocol allows multiple enumerators to simultaneously operate.

In general and as described below, the mapper/controller/enumerator (e.g., 202_{A}) uses the LLD2 protocol over any suitable communications link 318 to communicate with other network elements that respond to the LLD2 protocol commands and requests, and thus can be considered responders 320, where “responder” generally refers to a slave network protocol driver that receive commands from mappers, controllers and enumerators sent via the LLD2 protocol. As described below, the example mapper 202_{A} uses various data structures 322 and counters 324 or the like to perform the discovery and diagnostics operations. Note that any computing element capable of executing code to work with the protocol can serve as a mapper/controller/enumerator (that is a station) and/or a responder. Notwithstanding, as will be understood, the protocol is asymmetric by design so that responders only need to implement code that appropriately responds, with the bulk of the operations being handled by the mapper/controller/enumerator stations. This allows very lightweight responders to be implemented, e.g., on low end networking devices.

In general, the protocol exemplified herein allows for quick/fast enumeration (also referred to as fast discovery or quick discovery), network topology discovery, and QoS experiments (also referred to as network test, diagnostics and/or probing). With respect to each of the above types of enumeration, a node may broadcast discover packets (frames, repeated after some block of time known to each node, such as once every 100 milliseconds or 300 milliseconds, in case the query is lost) to query other nodes, e.g., to obtain their identities for enumeration. To this end, because in general a single node may request multiple of the above types of enumeration simultaneously or concurrently, an enumerator node is identified with a controlled identifier, e.g., based on the source MAC address and the type of enumeration (e.g. fast discovery or topology discovery). The enumerator node broadcasts its request along with the identifier (and a transaction identifier in case the enumerator node crashes or otherwise resets) to other responders in the network. The discover enumeration request that is broadcast also contains the identities of responders that responded (and whose responses were seen at the enumerator), up to some limited number, (such as 120) so that those nodes need not respond again.

The responders answer with Hello frames, (e.g., four times in one example implementation) containing data that are broadcast to everyone on the network by each responder. Note that a responder with multiple discover requests only needs to broadcast a single Hello to respond, since its Hello is broadcast and contains its information (i.e. the sending of responses multiple times is for the purpose of recovering from packet loss and is not necessary simply because there are multiple requests). Also, as described above, a given responder need not respond if it has seen itself identified in the payload. To preserve bandwidth, a responder may use a calculation to determine when to respond. For example, (after starting with a large estimate such as 10,000), each responder can estimate from the number of responses seen from other nodes how many responders are present in the network, and thereby estimate a response time as to how long it will take all responders to respond. In one embodiment, a random time within the response time is chosen to return the response. If a given responder does not see its identity acknowledged in a subsequent payload, it re-runs the estimates and tries again.

With respect to topology discovery, a candidate mapper needs to take steps to establish itself as the only mapper (i.e., no other mapper is currently mapping), and when selected as the mapper, collects data by which a suitable mapping algorithm determines the network topology. As with fast discovery, the mapper regularly sends out discovery packets, and the responder responds similarly, although an indication when another mapper already exists may be returned, to limit the network to one mapper.

Unlike fast discovery where the responder code transitions to an idle state (until again needed) once it sees its responder identity acknowledged, in topology discovery the responder code will enter a state in which it awaits commands from the mapper. This allows each responder to perform work on behalf of the mapper to collect topology-related data. One way data collection is accomplished is by emitting training and probing packets to collect the data, as described in the aforementioned U.S. patent application Ser. No. 10/768,582, which also describes a suitable mapping algorithm. Once established, a topology can be saved, displayed, compared to another topology to determine changes, and so forth.

However, because it is possible to have a responder emit more packets on the mapper's behalf than the responder receives from the mapper, and thus achieve a multiplying effect that causes a denial of service-type problem, the concept of a charge is provided, as generally described in U.S. patent application Ser. No. 10/837,434, which is also hereby incorporated by reference. Charge is determined based on the number of packets and size of the packets received from the mapper. Charge and emit packets are coordinated as an enforcement mechanism that ensures that the multiplier effect cannot occur. Type-length-value pairs (TLVs) value structures are also defined in the protocol, such as for sending large amounts of data, e.g., provided by the responder for showing in a visualization of the mapped network.

With respect to QoS diagnostic experiments, also referred to as network tests, diagnostics are more accurate at the link layer than at higher software layers, generally due to timing considerations. The protocol facilitates QoS data collection by allowing a controller to request other nodes to start keeping a history of statistics, e.g., packet counts. By querying for these statistics in timed probe and probegap tests, information can be obtained, such as corresponding to network traffic between nodes, bandwidth bottlenecks and so forth. For example, if two nodes unexpectedly have large packet counts between them, they are likely affecting traffic, and may, for example, be causing a problem in very busy network. Note that probegap tests are described in U.S. patent application Ser. No. 11/089,246, assigned to the assignee of the present invention and hereby incorporated by reference.

In one example implementation, packet counts are kept by each responder in a table of three hundred entries representing (up to) the last three hundred seconds (five minutes), with each entry corresponding to the packet count received during a one second interval. The controller may refresh the request to keep the counts so that a responder can stop counting, e.g., if not refreshed each minute.

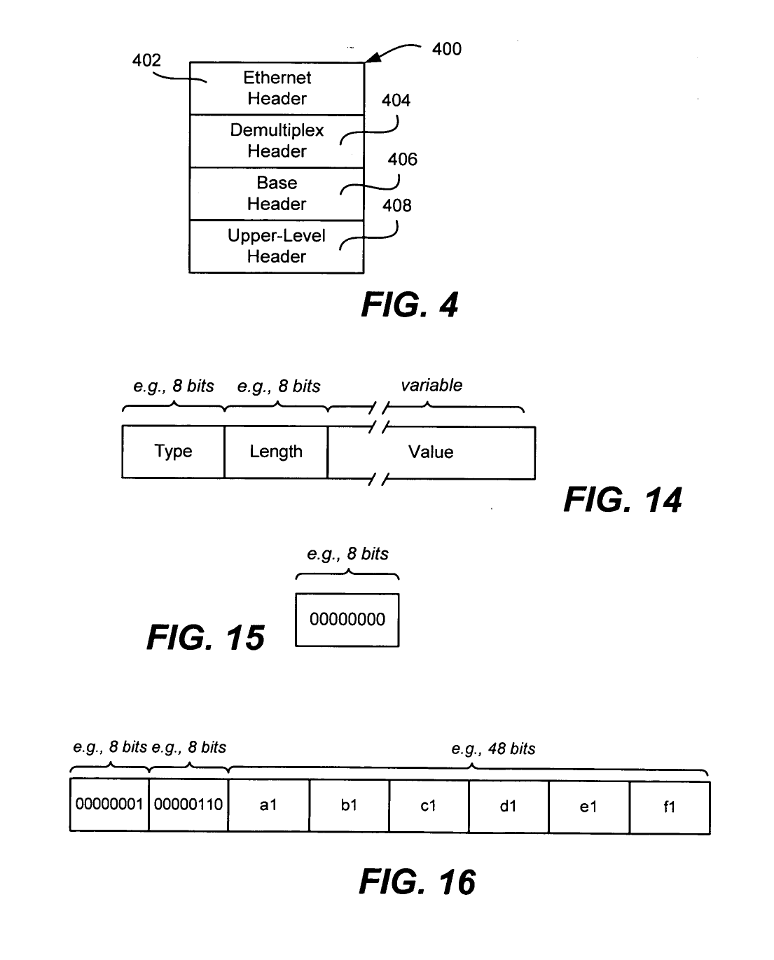

FIG. 4 is an example data structure 400 illustrating the position of each layer of header in the LLD2 protocol. As can be seen, in the example header hierarchy of FIG. 4, there is an Ethernet header 402, a demultiplex header 404 a base header 406 and an upper level header 408. In one example implementation, the protocol operates directly at the Ethernet layer 2 without recourse to IPv4 or IPv6. While the types of headers of the data structure 400 remain the same, their contents change depending on which of the three services is in operation, e.g., quick discovery, topology discovery and quality of service and diagnostics.

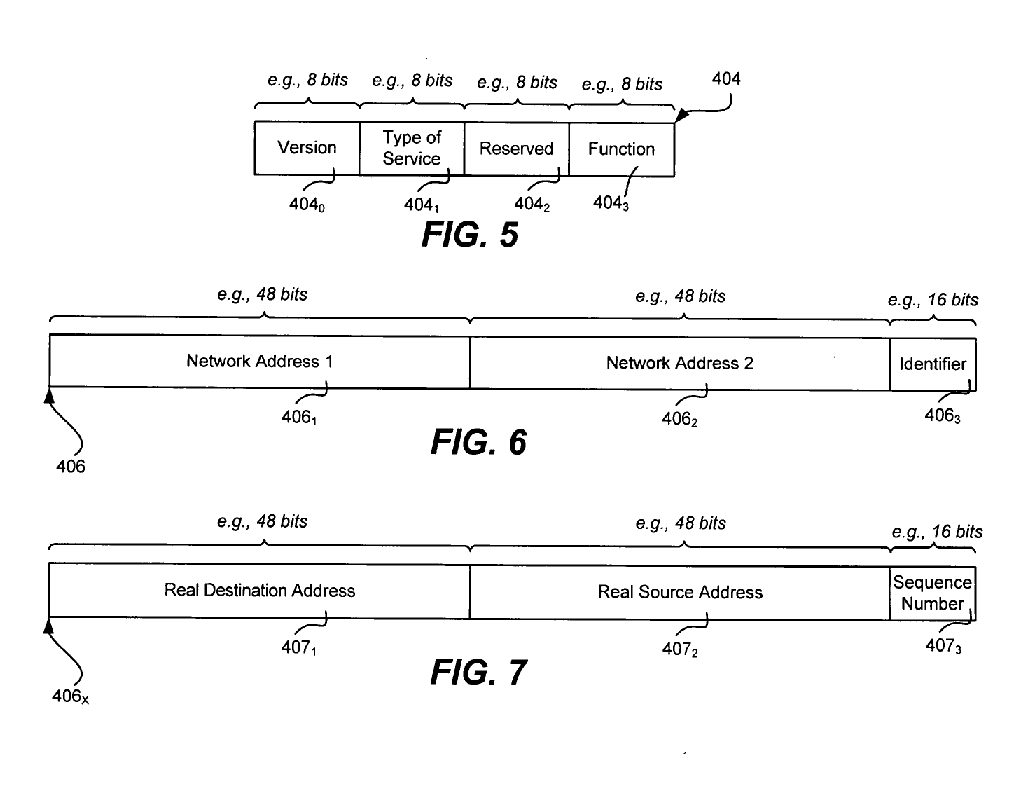

With reference to the base header, FIG. 5 represents one suitable example configuration for a demultiplex header format, comprising four eight bit fields 404₀-404₃. In this format, a value in a first eight bit version field 404₀ indicates the version of the demultiplex header, such as version 1, to allow for extending the protocol. A type of service field 404₁ field identifies the utility of the frame, e.g., in one embodiment 0x00 indicates quick discovery, 0x01 indicates topology discovery (and shares the function codes from above), and 0x02 indicates QoS diagnostics are in use. In version 1, any value between 0x03 and 0x7F is reserved for network experience use. Values ranging from 0x80 to 0xFF are reserved for third party use. A reserved field 404₂ (that in version 1 needs to be zero) is also defined.

A function field 404₃ unambiguously differentiates the multiplex of messages for a given type of service. In one example embodiment, the following functions are valid for service type 0x00 (quick discovery):
0x00=Discover
0x01=Hello
0x08=Reset

In one example embodiment, the following functions are valid for service type 0x01 (topology discovery):
0x00=Discover
0x01=Hello
0x02=Emit
0x03=Train
0x04=Probe
0x05=Ack
0x06=Query
0x07=QueryResp
0x08=Reset
0x09=Charge
0x0A=Flat
0x0B=QueryLargeTlv
0x0C=QueryLargeTlvResp

In one example embodiment the following functions are valid for service type 0x02 (network test):
0x00=QosInitializeSink
0x01=QosReady
0x02=QosProbe
0x03=QosQuery
0x04=QosQueryResp
0x05=QosReset
0x06=QosError
0x07=QosAck
0x08=QosCounterSnapshot
0x09=QosCounterResult
0x0A=QosCounterLease

FIG. 6 exemplifies the general concept of an example base header format, comprising a first network address field 406₁ (e.g., Network Address 1, 48 bits), a second network address field 406₂ (e.g., Network Address 2, 48 bits) and an identifier field 406₃, (e.g., 16 bits). The use of the network address fields is service type and function specific. The meaning of these fields can be summarized as having network address 1 comprise the real destination address, and having network address 2 comprise the real source address, for topology discovery and quick discovery, and for QoS diagnostics.

In FIG. 7, an example base header format is shown in one configuration (e.g., 406_{X}) that is suitable for topology discovery, and includes a (e.g., 48-bit) field 407₁ for the real destination address, a (e.g., 48-bit) field 407₂ for the real source address, and a sequence number field 407₃ (e.g., 16 bits).

The use of the identifier field is service type and function specific. The meaning of this field can be summarized as follows:

| Type of Service | Usage |
|---|---|
| Topology Discovery | Sequence Number or Transaction ID |
| Quick Discovery | Sequence Number or Transaction ID |
| QoS Diagnostics | Sequence Number |

Turning to an explanation of topology discovery, quick discovery and type-length-value pairs (TLVs), the responders 320 (FIG. 3) may handle activities in parallel. In the topology discovery case, an initial round of responder enumeration is performed. This is similar to what is done with quick discovery; in essence, topology discovery may be considered a superset of quick discovery. As used herein, the term “enumerator” is also generally used to identify any station that is issuing either a quick discovery request or the enumeration portion of a topology discovery request.

Topology discovery enumeration results in the selection of a single mapper to whom responders are associated. Once selected, the mapper is able to send additional commands to cause a responder to send topology probe packets, and to query which topology probe packets have been seen by the responder. Some topology commands require reliable communication between the mapper and the responder, as generally described below along with detailed packet format examples.

Note that in one implementation, there is a single topology discovery enumerator, but an unknown number of other enumerators. The topology enumerator wants to acquire a distributed lock on the network, and obtains a generation number that may indicate a current mapping iteration (or zero if unknown). In contrast, the other enumerators are only able to obtain limited information, e.g., what hosts exist and some information about them. In this implementation, multiple mappers may attempt topology discovery, however only one will ultimately succeed. The other stations participate in at least part of the enumeration process, e.g., enough to discover the current active mapper.

In general, for reliability against packet loss, enumerators send acknowledgements. A responder does not respond once it is already acknowledged. For efficiency, the responder keeps a small amount of state regarding each enumerator, which significantly reduces the load on the network. The assumption is that that the number of simultaneous active enumerators is sufficiently small, whereby the acknowledgements and small amount of state provide a more efficient mechanism than blind multiple transmissions. In general, most of the complexity is incorporated into the enumerator rather than in the responder so that when necessary, small embedded devices (e.g., from third party suppliers) may easily implement code to handle the responder requirements.

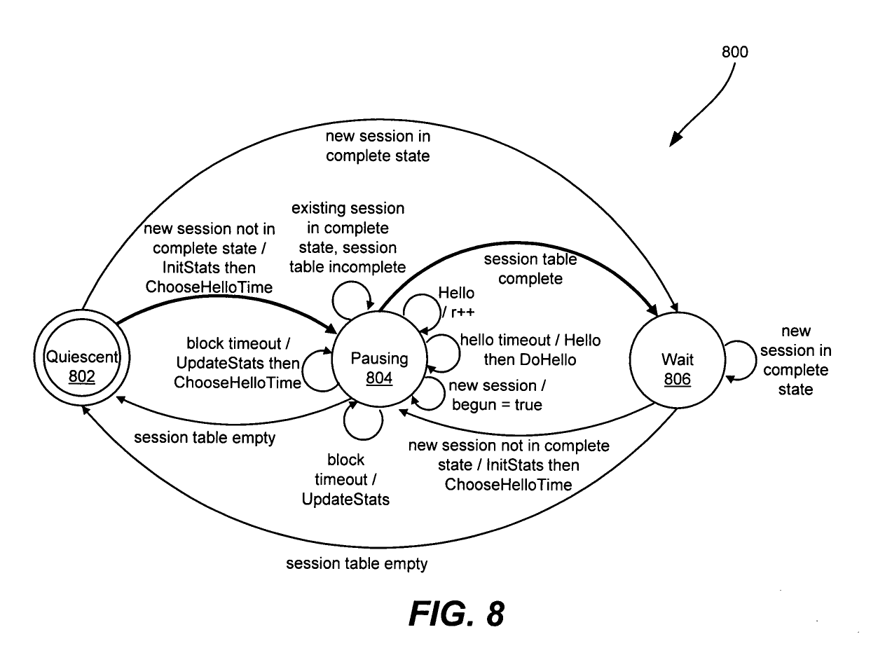

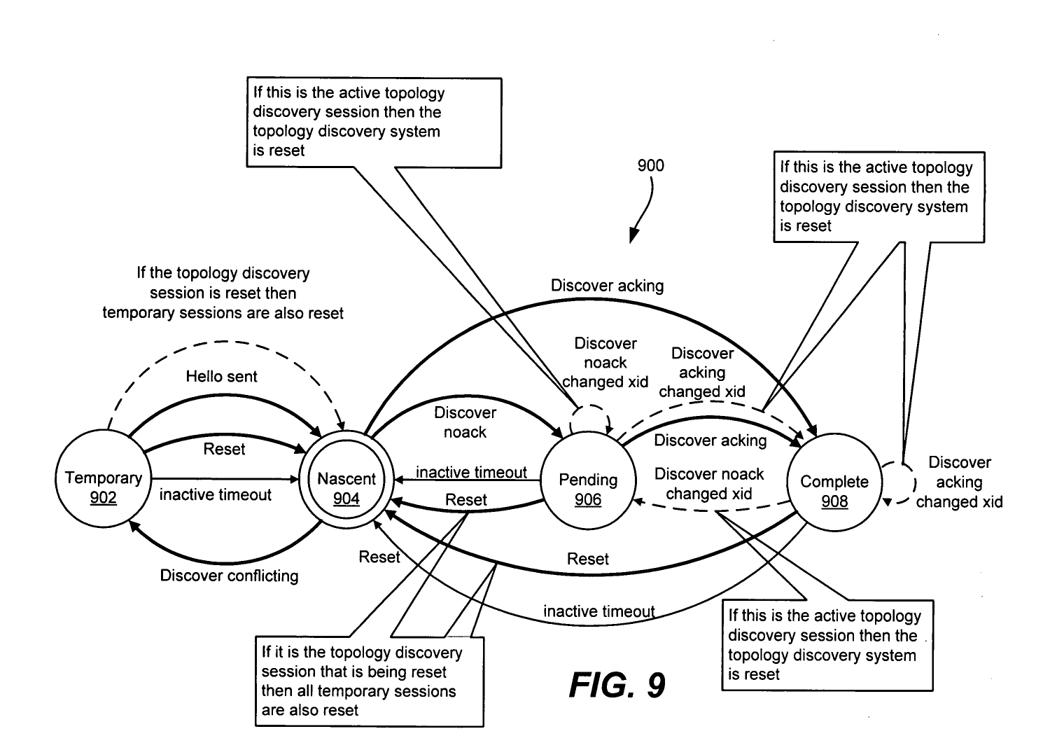

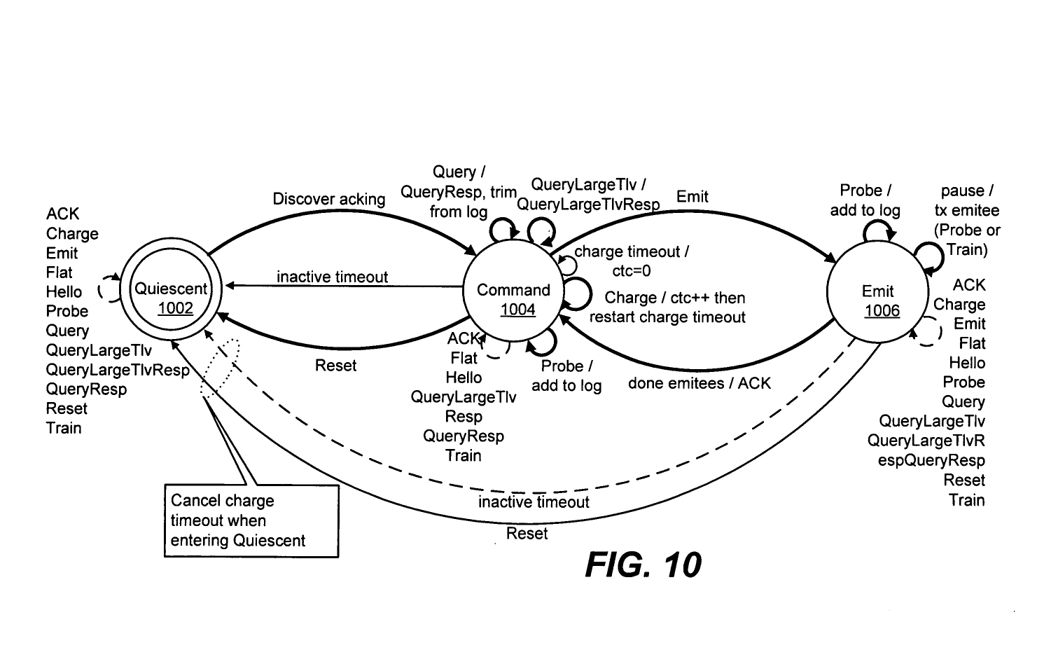

In general, three state machines are described. A first such state machine/engine 800, represented in FIG. 8, is directed towards operating the overall enumeration logic and is shared by topology discovery and quick discovery. A second state machine 900, represented in FIG. 9, and which may have multiple instances, is directed towards recording the state of the session associated with each enumerator, wherein a “session” generally refers to a context for managing the life cycle of a protocol in relation to a station, as identified by its MAC address. A third state machine 1000, represented in FIG. 10, is used to facilitate the actual topology discovery process, and operates once sufficient negotiation is made between the mapper and the responder via the enumeration state engine 800.

In FIGS. 8-10, (in decreasing likelihood of traversal), bold arrows (arcs) represent normal transitions, regular arrows represent expected recovery, and dashed arrows represent error recovery. Note that the arrow/arc labels are of the form “INPUT/ACTION,” where ACTION may be the name of a protocol message, which is output, and INPUT can be the name of a protocol message, or a timeout. When the/ACTION is missing this indicates that no action is taken.

As represented in FIG. 8, the enumeration state engine 800 operates in one of a plurality of operational states, (three are shown), including a quiescent state 802 to discover (not acknowledged), a pausing state 804 (pause, transmit Hello(s), and await acknowledgements), in which the enumerators acknowledge the responder, and a wait state 806. Note that the most likely outcome is to remain in the Pausing state 804, however given the right conditions the state machine 800 may transition to the wait state 806, as described below.

While in the quiescent state 802, responders need only listen to broadcast frames, which, in the case of topology discovery, comprises waiting for a discover frame to trigger an association with a mapper M, or in the case of quick discovery, comprising waiting for a discover frame to initiate an enumeration session. The pausing state 804 facilitates scalable discovery as to which stations are on the Ethernet. The Wait state 806 is where the Responder waits for enumerators or the mapper to finalize their session via a Reset frame. Responders leave the wait state 806 for the quiescent state 802 when all enumerators have either timed out due to inactivity or have successfully sent the Reset command.

As represented in FIG. 9, a session state engine 900, comprising a dynamic table referred to as a session table, stores per-enumerator state information and thereby enables the enumeration state machine to decide when to transmit Hello packets and when to transition to the wait state 806 (FIG. 8). A nascent state 904 is shown; the session table is indexed by computer and the current service (that is, quick discovery or topology discovery), against which is recorded the XID value (a Transaction ID, for example a 16-bit sequential value, or a random value without stable storage), the state, and the active time. The state in each table entry corresponds to one of pending 906, complete 908 and temporary 902. The random number generator should have a seed value that is not dependent on the current time, since the time could be synchronized on the network (indeed for a machine with multiple interfaces the time will be identical on the responder on each interface). An available alternative seed is based on the MAC address of the interface.

The following frame function types impact the session state and thereby indirectly the enumeration state:

| | |
|---|---|
| Discover | (Mapper -> BROADCAST) |
| Hello | (Responder -> BROADCAST) |
| Reset | (Mapper -> Responder, Mapper -> BROADCAST) |

Discover flavors include:

| | |
|---|---|
| Discover conflicting | came from mapper other than associated one |
| Discover noack | Seenlist (the list of seen responders) DOES NOT |
| | contain this responder's address |
| Discover noack | seenlist DOES NOT contain this responder's |
| changed xid | address and xid differs from session table |
| Discover acking | seenlist DOES contain this responder's address |
| Discover acking | seenlist DOES contain this responder's address, |
| changed xid | and xid differs from session table |

Turning to FIG. 10, the topology discovery state engine 1000 is shown as operating in one of a plurality of operational states, including three which are shown, namely a quiescent state 1002 in which the mapper acknowledges Hello in the enumeration state engine 800, a command state 804, and an emit state 806. While in the quiescent state 802, responders ignore packets marked for topology discovery. The command state 804 is reached when the enumeration state engine has successfully negotiated a topology discovery enumeration with a mapper (and only one mapper). The command state 804 is typically where responders spend most of the time during topology discovery; here responders execute emit and query commands from the mapper, and run with the interface in promiscuous mode. The emit state 806 is reached only if responders receive the emit command; as soon as the command is fully processed, they fall back into the command state 804. Responders go back to the quiescent state 802 on receiving the reset command, or when achieving a timeout after inactivity.

Discover flavors include Discover acking, in which the seenlist does contain this responder's address. The following frame function types are defined:

Used in Command and Emit states:

| | |
|---|---|
| Reset | (Mapper -> Responder, Mapper -> BROADCAST) |

Used in Command state:

| | |
|---|---|
| ACK | (Responder -> Mapper) |
| Charge | (Mapper -> Responder) |
| Emit | (Mapper -> Responder) |
| Flat | (Responder -> Mapper) |
| Query | (Mapper -> Responder) |
| QueryLargeTlv | (Mapper -> Responder) |
| QueryLargeTlvResp | (Responder -> Mapper) |
| QueryResp | (Responder -> Mapper) |

Used in Emit state:

| | |
|---|---|
| Probe | (Responder -> SPECIAL) |
| Train | (Responder -> SPECIAL) |

Returning to FIG. 8, the enumeration phase is handled by the enumeration state engine 800, and in general seeks to determine what stations are on the Ethernet, what generation number should be used, (during topology only), and whether another mapper is active. Note that the correct generation number needs to be used for a mapping iteration because of the way switches are forced to learn addresses. By the end of the phase, zero or one mappers will be active, and the correct generation number will be known.

Enumeration is designed to be highly efficient. A Hello packet is a valid response to any enumerators (both quick discovery and topology discovery) that are active, including those enumerators having an initial discover packet that has yet to be seen at the responder. In addition to the enumeration state machine 800, enumeration is handled by the session state machine 900, as described above. A session is defined by the (real) address of the enumerator and the service type (quick or topology).

The enumeration state machine 800 is defined by the overall session table. If there are no session table entries, then the enumeration state is quiescent 802. If there are sessions, but they are all complete, then the enumeration state is the wait state 806. In other conditions the enumeration state machine is in the pausing state 804.

The enumeration phase seeks to ensure that the switches know where the stations are. To this end, the Hello frames are broadcast, that is, so that switches can learn from their source addresses. Otherwise, if a station is disconnected then re-connected elsewhere, the switches may not yet be aware of this (and thus, if probed by the mapper mechanism, would provide inconsistent results).

One aspect of the enumeration phase is the avoidance of network overload caused, for example, by a very large network or one or more malicious mappers. To this end, a RepeatBAND algorithm is used, where BAND comprises an acronym for Block Adjust Node Discovery, a fast and scalable node enumeration algorithm, and RepeatBAND comprises an extension to BAND that supports multiple enumerators. In RepeatBAND, responders throttle their transmissions based on the presence of other Responders' frames. BAND and Repeat-BAND are further described in U.S. patent applications Ser. Nos. 10/955,938, 11/302,726, 11/302,651 and 11/302,681, each of which is also hereby incorporated by reference.

Example protocol actions for the enumeration phase in topology discovery include reset frames and discover-related frames. With respect to the reset frame, normally a reset is sent at the end of an enumeration, or after the completion of topology discovery. A reset is also sent at the start of an enumeration. The purpose of this is to clear any stale responders that may be left over from a previous mapping or enumeration run, e.g., if the previous reset was dropped and responders have not yet reached their inactivity timeouts.

If a corresponding session entry is found (if there is not one the packet is ignored), the session entry is deleted. The resulting enumeration state may be one of the pausing, wait or quiescent states, depending on the resulting session table. If the reset is for a topology discovery session entry (from the current mapper), then, in addition to the logic above, the topology state machine is also reset. In addition, any sessions in the temporary state are also reset.

An enumerator broadcasts a discover frame, which contains a set of responder station addresses that have been seen by the enumerator (initially the empty set) and an XID value whose purpose is to detect an enumerator that restarts without a corresponding reset. If the enumeration is for topology discovery, it also contains the mapper's current best guess for the generation number to be used in this mapping instance. This generation number may be 0 (an invalid generation number essentially meaning that the mapper has no information. The first discover by definition has the generation number set to zero (0).

When receiving a discover frame that arrives, the responder looks in the session table to match the MAC address and service code of the sender. If there is no entry, (or there is an entry but it has a different XID), then an entry is created and the session state is set, depending on whether the request contains an acknowledgement for this host (e.g., pending or complete). The active time is also updated.

If there is a session table entry (and it has the same XID), then the active time is updated. If the discover acknowledges this host, then the entry is set to complete.

In the situation of a discover frame for the topology discovery service, only one such session can be marked as pending or complete. If the responder does not know of an active mapper, then the responder remembers the current sender of the Discover frame as the current mapper. If there already is a current Mapper, then the session table entry is set to the temporary state. As described above, the enumeration state machine then transitions to the pausing, wait or quiescent states, as appropriate.

As described above, effects of discover on the topology state machine include that the topology discovery can be considered an extended form of quick discovery. The responder takes certain specific actions for enumeration of topology sessions. One of these, as also described above, ensures that a single topology session is associated with a responder by setting subsequent topology sessions to the temporary state rather than the pending or complete states. In addition, the idle timeout for the topology session is different from the quick discovery session.

The first topology session that is created (from nascent state into pending or complete state in FIG. 9) becomes the one true topology session, and the responder records the address of the mapper. Subsequent topology sessions will be created in the temporary state until the true topology session is ended. As soon as the session is created (leaves nascent state), the responder can be considered to be “associated” with this Mapper. Even though the Hello will not be sent immediately, the mapper is associated immediately, to limit the window of concurrency if multiple mappers attempt to control the network simultaneously.

If the Discover frame's source address is different from the mapper's real address, then this discrepancy is noted (to indicate that the mapper is behind a WET11-style device). The responder also puts its interface into promiscuous mode, because although it is not needed until the responder's topology state engine goes into command state, it may take a while for the hardware to be re-programmed.

In the pending state, if acknowledged, the topology state machine 1000 transitions to the command state. Note that this is in addition to the transition of the topology session changing to the complete state (and any resulting change in the enumeration state machine).

The Responder sends a Hello frame in the pausing state as determined by the RepeatBAND load control mechanism. The frame contains various information in a packet format, as described below. When the Hello is sent, the session entries in the temporary state in the session table are deleted. The enumeration state machine then transitions to one of the pausing state (if there are any session table entries in the pending state), the wait state (if all the session table entries are in the complete state), or the quiescent state (if the session table is empty).

With respect to generation numbers, responders store the previous generation number used in mapping the network. This stored value may be zero, meaning that the responder does not know a valid generation number. Responders need to zero their stored generation number if they are disconnected or powered down, since they may be reconnected to a different network, where this generation number is not valid.

The initial discover(s) from the mapper are likely to have the generation number zero (unknown). The responder places its currently stored generation number in the Hello frames that it sends to the mapper, even if the discover frame is advertising some other (non-zero) generation number. A responder updates its stored generation number by setting it to the value specified by its mapper in discover if the value specified by the mapper is non zero, and the responder has been acknowledged by the mapper. This occurs on the receipt of the acknowledging discover that causes the responder's mapping state engine to transition to the command state, and also on the receipt of a discover while the mapping state engine is already in the command state.

The mapper handles generation numbers generally to generate fresh MAC addresses which are unknown to the switches in the network. This avoids needing to reboot switches between mapping runs, and thus an as-yet unused generation number is selected. The enumeration phase does this by reaching a consensus amongst the stations on the network, each of which attempts to remember the previously used generation. This requires that the responders on the network communicate with the mapper. The mapper has the final choice and may overrule responders that may not be up-to-date (e.g., if they were moved between networks).

In one implementation, mappers do not store a previous generation number, because there may be multiple mappers operating on a network and mappers do not snoop to keep their generation number synchronized. Instead, mappers use the generation numbers from the responders' Hello frames to determine the correct generation number.

More particularly, as Hello frames arrive at the mapper, it decides which generation number to use for this mapping run by taking the newest generation number volunteered by the responders and adding one, wrapping it as appropriate and ensuring it does not become zero. This new generation number is then used in subsequent discover frames broadcast by the mapper. The mapper may later revise its generation number choice as additional Hello frames arrive. If no responder has volunteered a valid generation number, then the mapper selects a new generation number at random (ensuring it is non-zero), and broadcasts a last discover to disseminate this generation number to the responders. This permits a mapper to guess a generation number before it knows that all possible responders have sent a Hello frame (it does this in general since it can never know when it will receive a late Hello). A generation number is considered to have been consumed when the mapper broadcasts a discover containing it.

Inactivity timeouts are determined by a timer that runs regularly. When the timer determines that there are stale entries in the session table, then it treats them as if they had been reset.

Turning to the command phase, the command phase applies to the topology state engine 1000. This state is the principal state used to determine the topology of the network. In general, the mapper commands the responder to send probe packets using the emit command and the emit state, and the responder records any probe packets it sees for subsequent collection and analysis by the mapper. While in this state, the responder is in promiscuous mode (if supported on the interface).

For handling discovery, if the mapper broadcasts a reset frame, the mapper indicates that mapping is over for associated responders, either through successful termination of the algorithm on the mapper, or because the mapper is aborting this mapping instance (e.g., when another mapper is active). A responder only acts on a Reset if its source address matches the Mapper's address with which this Responder is currently associated.

For observing network probes, when a responder receives a probe frame, it adds the frame's source and destination addresses to its “sees” list. Responders should discard “train” frames.

The sees list is normally small, however its maximum size can be approximately as large as the size of the network, which can be up to Nmax entries, (a maximum size of a network to which the protocol is designed to scale). An error bit exists to permit an exhausted responder to indicate failure to record an entry; this may cause complete failure to map the network, depending on the topology. Responders record probes even if their real source address is equal to the responder's own address. This is because the mapper needs to detect some broken chipsets that replicate and reflect packets back.

The Query/QueryResp commands are sent by the mapper to a responder. Query asks the responder's mapping engine to return its list of received probe information. The Responder should put as many received entries as will fit into a QueryResp frame, and send it back to the mapper. The responder then removes the transmitted entries from its recorded list. If there are more pairs in its list than will fit in a single Ethernet frame, the responder sets the “more” bit in the QueryResp, prompting the mapper to continue sending Query frames until it has gathered all of the entries. If a failure to observe a probe has occurred, the responder sets the “error” bit in the QueryResp packets. The error flag should be cleared only once the “sees” list has been completely drained.

There are some TLVs (type-length-value pairs) that may be too large to return in a single Hello frame. Such TLVs may be returned using the QueryLargeTlv mechanism. TLVs are described below with reference to the Hello and QueryLargeTlv packet format.

QueryLargeTlv and QueryLargeTlvResp operate in a very similar way to Query and QueryResp. QueryLargeTlv is sent to the responder's mapping engine (the enumeration engine does not support this frame) asking it to return as many octets as possible, starting from a specific offset, for a specific TLV type. The responder acknowledges by returning the maximum amount of octets possible that will fit in a single Ethernet frame from the specified offset. If there are more octets to return, the responder sets the “more” bit in the QueryLargeTlvResp, prompting the mapper to continue sending QueryLargeTlv frames with updated offset values until it has gathered the full TLV. In one implementation, the mapper does not know how large the TLV is until the final QueryLargeTlvResp frame is returned, that is, with the “more” bit set to zero. A large TLV may be limited, e.g., to at most 32,768 octets in size. The mapper may ignore a TLV that exceeds this size limit.

Charge/emit provides a mechanism to prevent denial of service style attacks. For example, a requirement may be implemented such that the mapper needs to send as many bytes to the responder as the mapper can trigger the responder to send on its behalf. This is designed such that the protocol cannot be abused to amplify attacks on others. To this end, a responder adds an additional check for Emit commands; there needs to be sufficient transmit credit in bytes and packets available to send both the designed packets and any requested acknowledgement. In command state, the responder's mapping engine is operating the charge management functionality. If it receives a unicast Emit or Charge message from the mapper, then the current transmit credit (CTC) at that responder is incremented by the Ethernet frame size of the received message in bytes, and by one packet.

If there is insufficient CTC to execute the corresponding wire transmissions in response to an emit from the mapper, the responder sends a flat message, wherein the flat message conveys the current transmit credit (CTC) built up at the responder so that a mapper can decide whether it needs to build up more credit before it can get the responder to perform a desired emit-related action. It is up to the mapper to build up additional credit (using charge or emit) if a flat is received. Once it is determined that an Emit will be attempted, the charge is zeroed. This means that if an Emit fails part way through, the mapper has to recharge from zero. Note that small amounts of bytes charge can be transferred simply by appropriately padding an emit frame.

In order to prevent a mapper building up a large amount of charge at multiple responders and releasing this at the same time against a target, the charge that can be accumulated is limited. In one implementation, recommended values are 65536 bytes and 64 packets. In addition, unused charge expires after a time; when the value of the charge goes non-zero the timer CTC_RESET_TIMER is started (e.g., at a value 1000 milliseconds). If the timer fires before an emit uses the charge, then the charge is set to zero. An emit that is accepted cancels the timer.

To prevent having a charge that has been built up from being misappropriated by an attacker, any emit request that requires charge (beyond that which the emit itself carries) is required to carry a sequence number. An emit request that does not succeed because of insufficient charge causes that sequence number to be consumed. The flat carries the sequence number in return. One rationale is that the transmission of the flat cancels out the packet charge effect of the emit, whereby any retransmission is also guaranteed to fail. Because at least one charge is sent before the emit can be retried, the sequence number space cannot be polluted.

Charge packets may optionally carry a sequence number. A charge packet that carries a sequence number causes a flat to be returned carrying the current charge values. Note that such a charge packet will therefore not increase the values of the charge (in packets, though it may increase the byte charge count), but is instead useful for permitting the value of the charge reached to be determined.

Turning to an explanation of the emit phase, an emit frame is sent by the mapper to a responder and includes a list of (type, pause, src, dst) quadruples. These are processed sequentially in order, and each requests that the responder transmits a train or probe frame with the given source and destination Ethernet addresses after the specified pause time.

The “type” parameter allows the mapper to specify whether a train or probe frame is needed, and pause specifies how long (in milliseconds) to wait after sending the previous frame before sending this frame. The pause is used because some switches may take approximately 150 milliseconds to update their port filtering databases, so back-to-back train, probe frames are not forwarded correctly.

On receipt of a valid Emit frame, the mapping engine temporarily goes into the emit state for the duration of the emit command. The mapping engine transitions back to the Command state after the Emit frame has been fully serviced.

For security reasons, security checks may be performed by a responder before putting train or probe frames on the wire. For example, a check may be made to ensure that the Emit request has note been sent to the broadcast address. Also, in one example implementation, the train and probe src (source) need to be the responder's normal address, or a known OUI (Organizationally Unique Identifier, or the three most significant octets of an Ethernet address as maintained by the IEEE Registration Authority). Further, the train and probe dst (destination) cannot be Ethernet broadcast or multicast. The responder validates the security criteria on all triples in the list before starting to transmit any of them; if the security checks fail one or more triples, then none of the triples in the Emit frame are to be transmitted, and the emit is not acknowledged.

If an emit frame includes a sequence number, an ACK is only sent by the responder after all train and probe frames requested have been sent successfully. If a responder is part of the way through sending a list of trains/probes, and the responder detects a failure to transmit (e.g., due to a link failure), the responder stops processing the list at this point, and refrains from sending the remaining train/probe frames in the list. The responder does not generate an ACK for this failing sequence of frames; it is the mapper's duty to recover from this sort of failure. Should the mapper retransmit the emit request that failed (i.e., using the same sequence number), the responder restarts processing it from the beginning of the list.

While a responder is processing the transmit list (i.e., the mapping engine is in Emit state), the responder is not to process Emit, Query, or QueryLargeTlv frames sent to it by the mapper, but instead needs to continue to process reset frames and discover frames. Probe packets are recorded as in the command state. Such Emit, Query, or QueryLargeTlv frames are to be discarded (because queueing them opens up a denial of service attack), although this behavior may be dependent on the operating system over which the responder is implemented.

To avoid amplification, the responder requires that there be enough charge (in both packets and bytes) to handle emit (including the cost of sending a possible acknowledgement). If there is not enough charge (and the emit is intended to be reliable, e.g., a sequence number is present) then a Flat is returned. Note that an emit contains enough inherent charge to send a Flat.

Network load control and scalability of the enumeration process (for both quick discovery and topology discovery) is handled by the Repeat-BAND mechanism, as described above with reference to the state transitions and frames that are sent. The timing of these frames and state transitions are accomplished in that responders send Hello frames in the Pausing state, but do not send them immediately. Instead, responders measure the network load over a number of loosely-synchronized rounds also called blocks of approximately fixed duration Tb (the “block time”). Responders use these load measurements to calculate a running count of the number of responders that are active on the network. Responders send a frame in a block with a probability which is dependent on this estimate.

When a responder transitions to the pausing state, the responder initializes the estimate of the number of machines (N) on the network to Nmax, and sets the initial number of observed Hello responses to zero. The responder then begins the first round. Note that the responder does not begin to monitor the network load until it is itself potentially ready to transmit; otherwise a large number of similar machines may think the network load is low and become ready simultaneously.

At the start of each round in the pausing state, a responder samples its random number generator and chooses a time that is uniformly distributed between zero and N times 1. If the time is less than Tb, then the responder sends its Hello at the chosen time. If the time is greater than or equal to Tb, then the Responder does not send a Hello in this round. If the Hello frame is sent, the retransmit counter is decremented for each pending session in the session table, and each temporary session is deleted. When a counter reaches zero, the session is marked complete even if it has not been acknowledged. This action may cause the responder to exit the pausing state. Note that the topology session may therefore be complete without being acknowledged; in this case the topology state machine does not transition to the command state.

During the block, the responder counts the Hello and Discover messages seen on the network (including its own transmission if any) in a variable named r. At the end of the block, the responder updates the estimate of the number of active responders on the network based on the count of frames during the block, and the measured length of the block (in milliseconds) in a variable called Ta (where Ta is likely the same as Tb, but on some platforms can be longer due to scheduling delays). The estimate is calculated as follows:
Value=RoundUp(r*N(old)*I/Ta);
Bound=RoundUp(N(old)*Gamma/(Beta*Alpha));
N(new)=Max(Bound, Min(100*N(old), Value))

Note that if properly arranged, the estimate value will never be zero or negative, and can be implemented entirely in integer arithmetic.

The Responder then checks the “begun” flag (as described below). If the flag is set and the estimate N is below half of Nmax, then it is doubled; otherwise if it is below Nmax it is set to Nmax. The begun flag is then cleared:

if (begun)
if (N < Nmax/2) N *= 2; else if (N < Nmax) N = Nmax;
begun = false;

The responder then begins the next round.

By way of summary, in the enumeration state machine 800, actions include the following:

| Action | Meaning |
|---|---|
| ChooseHelloTime | Choose Hello time Th randomly from |
| | 0 .. Ni*I; |
| | if Th < Tb queue “hello timeout” for Th |
| | if none pending. |
| DoHello | For any session, if session is temporary delete it; else |
| | if session is pending decrement Txc(session) and mark |
| | as Complete if Txc(session) == 0; If topology session |
| | is marked as Complete, topology state machine DOES |
| | NOT transition to Command state. |
| InitStats | N = Nmax; Txc(session) = TXC; begun = false; |
| | Queue “block timeout” for Tb. |
| ResetNi | Ni = Nmax; r = 0. |
| UpdateStats | Value = RoundUp( r * N(old) * I / Ta ); |
| | Bound = RoundUp( N(old) * Gamma / Beta * |
| | Alpha) ); |
| | N(new) = Max( Bound, Min(100*N(old), Value) ); |
| | r=0; if (begun) |
| | if (N < Nmax/2) N *= 2; else if (N < |
| | Nmax) N = Nmax; |
| | begun = false; |
| | Queue “block timeout” for Tb if none pending. |

Note that in one current implementation, the value of Nmax is set to 10,000, the value of Tb is set to 300 ms, the value of I is set to 6.67 ms, the value of Alpha is 45, the value of Beta is 2, the value of Gamma is 10, and the value of TXC is 4. Also note that in one current implementation, the value of HELLOTIMEOUT (Hello timeout) is currently set to fifteen seconds, and a suggested value for CMDTIMEOUT (command timeout) is sixty seconds.

Received discover packets are handled differently depending on whether the enumerator is known to the responder (a session already exists) and the responder is acknowledged. Discover packets are counted towards the load estimation. If a new session is created directly into the complete state, it has no effect on the load control system. If an already existing session transitions to the complete state, it has no effect on load control (unless it causes a simultaneous transition of the enumeration state machine out of the pausing state). A discover for an existing session that does not acknowledge the responder also does not change load control.

Discover frames that create a new session are the main cause of a change to load control. The transmission count for the session is set to TXC. If this session is causing a transition to the pausing state, then the load control is initialized as described above. If this new session is not causing a transition to the pausing state, then the begun flag is set, which impacts load control at the end of the current block.

With respect to reliability, because Ethernet is a best-effort medium, some frames may be lost. To cope with this, several techniques may be used. For example, in the enumeration phase, discover frames may be retransmitted by the enumerators, and responders may check the given station list to make sure the enumerator has seen them, re-broadcasting their Hello if needed. If the enumerator needs to list more responders than will fit in a single discover frame, the enumerator sends multiple (sequential) discover frames, e.g., to incrementally acknowledge the responders. Thus, a responder's enumeration state engine is woken from Quiescent 802 (FIG. 8), and enumerators reliably see responders.

In the topology discovery state engine's Command state 1004 (FIG. 10), reliability is ensured by using sequence numbers (i.e., the Identifier field in the Base header) in mapper requests, and having the responder quote this same sequence number in any response packet. The request/response pairs are as follows:

| Mapper | Responder |
|---|---|
| Emit | ACK or Flat |
| Query | QueryResp |
| Charge | Flat |
| QueryLargeTlv | QueryLargeTlvResp |

The following table shows which function types are allowed to be sent to the broadcast address, which may have a non-zero sequence number, and which are required to have a non-zero sequence number:

| | | | Sequence |
|---|---|---|---|
| Function | Value | Broadcast? | number? |
| Discover | 0x00 | Required | Required |
| Hello | 0x01 | Required | No |
| Emit | 0x02 | No | Permitted |
| Train | 0x03 | No | No |
| Probe | 0x04 | No | No |
| Ack | 0x05 | No | Required |
| Query | 0x06 | No | Required |
| QueryResp | 0x07 | No | Required |
| Reset | 0x08 | Permitted | No |
| Charge | 0x09 | No | Permitted |
| Flat | 0x0A | No | Required |
| QueryLargeTlv | 0x0B | No | Required |
| QueryLargeTlvResp | 0x0C | No | Required |

The Discover frame uses a sequence numbering mechanism that differs from that used by the other function codes, as further described below. In particular, emit and charge are the only frames which can optionally have a sequence number. Request frames sent with a non-zero sequence number require an acknowledgement of some kind (i.e. Ack, QueryResp, Flat or QueryLargeTlvResp), and these packets are thus sometimes referred to as “Ack-like”. The request will be re-transmitted by the mapper until the responder acknowledges it (or the mapper times out and declares the responder dead.) Note that because requests are only ever sent from the mapper, the responder does not need to implement any timeout and retransmission logic; it is up to the mapper to timeout and retransmit the request if an Ack-like frame is not forthcoming (this helps keeps the responder simple). To allow this, the responder keeps a copy of the last Ack-like frame that the responder sent to the mapper, together with its sequence number; if the mapper sends a request with a matching sequence number, the kept frame is retransmitted without invoking higher-level responder logic.

Turning to an example explanation of usage of the state machines, consider a first example scenario correspond to a Quick Discovery request from a single Mapper to an idling responder.
1. A Discover packet (Type of Service: Quick Discovery) arrives from Mapper, as the Enumeration state engine 800 (FIG. 8) picks it up in the Quiescent state 802.
2. A new session is created in the session table 900 (FIG. 9). Since the Discover packet does not ack the Responder, the session is created in Pending state.
3. In the Enumeration state engine 800, a new session that is not in the Complete state results in the queuing of a Hello packet using the InitStats and ChooseHelloTime functions. The Enumeration state engine 800 transitions to the Pausing state 804.
4. A Hello is sent by the Responder while in the Pausing state 804, causing the Enumeration state engine 800 to transition to a Sent state, (represented by the hello timeout/Hello arc).
5. The mapper eventually follows up with a Discover explicitly ack-ing the responder in station list of Discover upper-level header. According to the session table diagram (FIG. 9), an acknowledgement of a Session in Pending state results in transition of the session to Complete state (the Discover acking arc).
6. In FIG. 9, since the session table has only complete sessions, the Enumeration state engine 800 transitions from Sent state to Wait state (the table has only the complete sessions arc).
7. While in Wait state, on a network with just one Mapper, the completed session above would eventually time out, or the Mapper may send a Reset packet. FIG. 9 shows what happens to the session when either of the conditions described happens (Reset and inactive timeout arcs). The result is the session being destroyed (i.e. Nascent state) causing the Enumeration state engine (FIG. 9) to transition to Quiescent state (session table empty arc).

A second example scenario corresponds to a topology discovery request from a single mapper to an idling responder.
1. A Discover packet (Type of Service: Topology Discovery) arrives from the mapper, as the Enumeration state engine 800 (FIG. 8) picks it up in the quiescent state 802. At this point, there is also no active topology discovery request, so the mapping engine (FIG. 10) is also in its quiescent state 1002.
2. A new topology discovery session is created in the session table (FIG. 9). Since the Discover packet does not ack the Responder, the session is created in the pending state 906. (Note that only one topology discovery session may be in pending or complete state at any given time; subsequent topology discovery sessions will be in the temporary state 902.)
3. In the Enumeration state engine 800, a new session that is not in the Complete state results in the queuing of a Hello packet using the InitStats and ChooseHelloTime functions. The Enumeration state engine 800 transitions to the Pausing state 804.
4. A Hello is sent by the responder while in the pausing state 804, causing the enumeration state engine 800 to transition to a sent state (hello timeout/Hello arc).
5. The mapper eventually follows up with a Discover explicitly ack-ing the responder in station list of Discover upper-level header. According to the session table diagram of FIG. 9, an acknowledgement of a session in the pending state 906 results in transition of the session to the complete state 908 (the discover acking arc). According to the mapping engine state diagram (FIG. 10), the ack-ing of the topology discovery session also results in the transition of the mapping engine 1000 from quiescent state 1002 to the command state 1004 (the discover acking arc). This is a transition that a discover packet with the quick discovery type-of-service does not make.
6. Returning to FIG. 9, since the session table has only complete sessions, the enumeration state engine 800 transitions from the Sent state to the wait state 806 (as the table has only complete sessions arc).
7. From here on, Discover, Hello and Reset frames are still processed by the enumeration state engine 800 (FIG. 8). Other frames are directed to the mapping state engine 1000 (FIG. 10; however, those that are not marked for topology discovery type-of-service are ignored). The logic for timing out or resetting a session is still handled by a combination of the Enumeration state engine 800 and the session table 900 (FIG. 9) as described in Step 7 of the first scenario.

Returning to FIG. 7, the base header format for topology discovery (e.g., 406_{X}) includes real source and destination Ethernet addresses, which are set by a sender to its own Ethernet address and its intended destination Ethernet address respectively; these fields are needed because the source and destination address fields of the Ethernet header are rewritten by some network devices and thus may not survive an end-to-end transmission. If the Responder receives a command from the mapper where the real source address is not equal to the Ethernet header's source address, then this is a hint for the responder to broadcast a subsequent response, if any.

The sequence number ensures reliability of certain packets in the protocol. While the frames in this protocol have a sequence number field, it needs to be zero in some cases. Commands and requests from the mapper to the responder may have no sequence number (in which case the field is zero) or may be sequenced in which case they have a non-zero sequence number. Sequence numbers are advanced using increment in ones-complement arithmetic; that is, they advance from 0xFFFF to 0x0001 and skip 0x0000.

The first sequence number of a topology discovery session may have any (non-zero) value and will be taken by the responder. Subsequent sequence numbers need to have the correct value (either a retransmission which is re-acknowledged as mentioned above, or the successor value.) The discover frame uses the 16-bit sequence number field for its Transaction ID (XID) which is just a simple sequence number. A purpose is to detect an enumerator that terminates without the responder realizing it and restarts before the idle time has expired. If the XID value used by an enumerator changes, then the responder assumes that the previous session was reset before processing the packet.

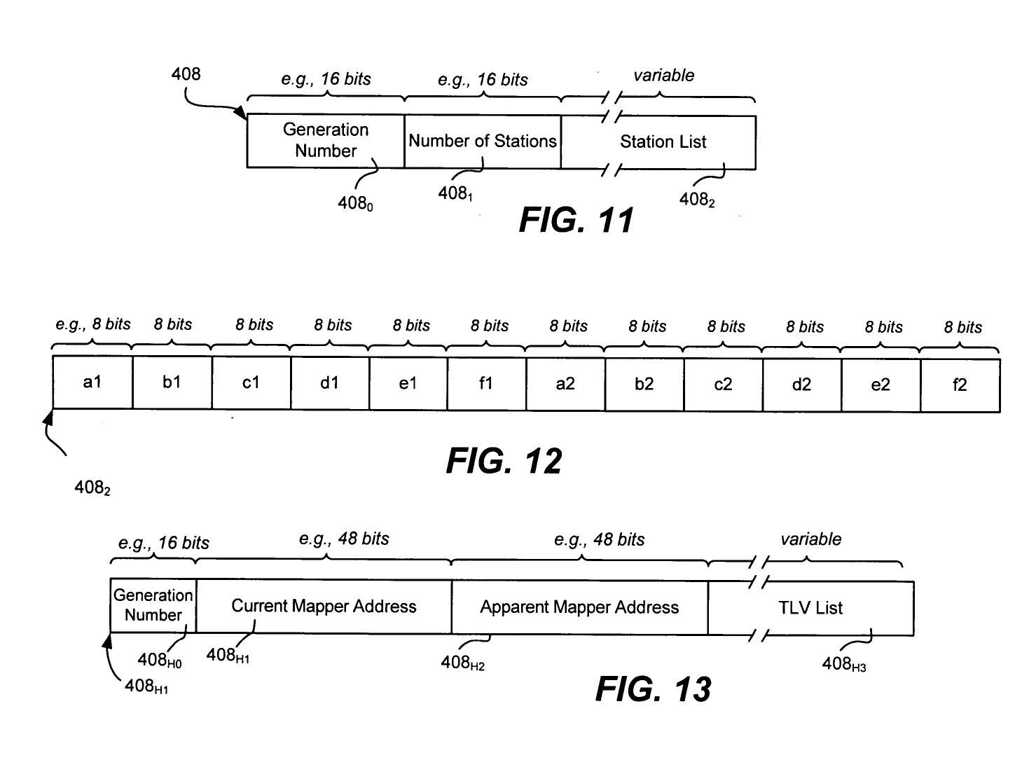

The discover header immediately follows the base header 406, as represented in the discover upper-level header 408 of FIG. 11. The discover upper-level header 408 includes a generation number field 408₀ (e.g., 16 bits) that allows the mapper to negotiate a generation number with the responders that respond to the discover frame. Ultimately, this number allows the mapper to generate a unique range of Ethernet addresses from the reserved topology discovery address pool that do not conflict with those from a recent topology discovery process.

The number of stations field 408₁ (e.g., 16 bits) indicates the number of station addresses that are present in the following variable-length station list field 408₂. The station list field 408₂ comprises a sequence of six-octet Ethernet addresses. The length of the sequence is given by the preceding number of stations field 408₁.

By way of example, a station list 408₂ containing two addresses a1:b1:c1:d1:e1:f1 and a2:b2:c2:d2:e2:f2 is encoded as shown in FIG. 12. Note that in one implementation, this encoding can only be used up to a maximum of 246 Ethernet addresses, so that the discover frame can fit into a single 1514 octet Ethernet frame:

$$\begin{matrix}1514 - \\ 14 ( Ethernet header ) - \\ 4 ( Demultiplex header ) - \\ 14 ( Base header ) - \\ 4 ( Discover header ) \\ 1478 / 6 octets per address = 246 addresses .\end{matrix}$$

In this example implementation, the mapper arranges its discover inter-transmission time so that no more than 246 addresses need to be acknowledged at any time. If more responders reply than will fit, however, the mapper sends a plurality (e.g., series) of discover frames, enough to acknowledge all of the responders that replied.

For a Hello upper-level header format, Hello frames are broadcast so that switches are made aware of the location of the responders. A Hello header 408_{H} following a base header is represented in FIG. 13, and includes a generation number field 408_{H0} (e.g., 16 bits) that contains the responder's current generation number.

A current mapper address field 408_{H1} (e.g., 48 bits) contains the active mapper's real Ethernet address as given in the real source address field in the base header of the discover frame that initiated the active topology mapping request. This field is zeroed if there is no active topology mapping session. An apparent mapper address field 408_{H2} (e.g., 48 bits) contains the mapper's Ethernet address as given in the source address field in the Ethernet header of the discover frame that initiated the active topology mapping request. This field is zeroed if there is no active topology mapping session. Note that the real destination address field in the base header of the Hello frame is set to the mapper's actual Ethernet address, so that if there is more than one mapper active, mappers can ignore replies from Responders other than theirs. All but one mapper will eventually be reset and thus want to abort their associated clients, so each client is associated with only one Mapper.

The TLV (type-length-value) list field 408_{H3} is a variable-length field that gives properties known by the responder about the interface on which it is running. In certain situations, a TLV may be too large to fit into a Hello frame, particularly in the presence of other TLV properties that take up their share of space. The responder may choose to declare certain TLVs as zero length. This tells the mapper to issue one or more QueryLargeTlv requests at a later time for each such TLV. Each valid QueryLargeTlv request is followed up with a QueryLargeTlvResp response, so if the TLV is sufficiently large, multiple QueryLargeTlv requests may have to be issued. Note that only specific TLVs will be allowed such behavior. FIG. 14 provides an example of a TLV entry.

The following is a list of TLVs that a Responder needs to support, with the exception of TLVs noted with the <*optional*> tag in its corresponding description.

| Type | Length | Description |
|---|---|---|
| 0x00 | — | End-Of-Property list marker. This TLV occupies only 1 octet; it has |
| | | no length octet. |
| 0x01 | 6 | Host ID. Used to uniquely identify the host that the Responder is |
| | | running on. |
| 0x02 | 4 | Characteristics. Used to identify various characteristics of the Responder |
| | | host and network interface. |
| 0x03 | 4 | Physical Medium. Used to identify the physical medium of a network |
| | | interface using one of the IANA-published ifType object enumeration |
| | | values. |
| 0x04 | 1 | Wireless Mode. Used to identify how an IEEE 802.11 interface |
| | | connects to the network. Note that this applies to 802.11 interfaces |
| | | only. |
| 0x05 | 6 | 802.11 BSSID. Used to identify an IEEE 802.11 interface's |
| | | associated access point. Note that this applies to 802.11 interfaces |
| | | only. |
| 0x06 | var. | 802.11 SSID. Used to identify an IEEE 802.11 interface's |
| | | associated access point. Note that this applies to 802.11 interfaces |
| | | only. |
| 0x07 | 4 | IPv4 Address. Used to carry the interface's present and active IPv4 |
| | | network address. |
| 0x08 | 16 | IPv6 Address. Used to carry the interface's most relevant IPv6 |
| | | network address. (In most cases this should be the Global v6 |
| | | address). |
| 0x09 | 2 | 802.11 Maximum Operational Rate. Used to identify the maximum |
| | | data rate at which the radio can run. Note that this applies to 802.11 |
| | | interfaces only. |
| 0x0A | 8 | Performance Counter Frequency. Identifies how fast the timestamp |
| | | counters run in ticks per second. Note, this TLV is <*optional*>. |
| 0x0C | 4 | Link Speed. Used to identify the network interface's maximum |
| | | speed in units of 100 bps. Note, this TLV is <*optional*>. |
| 0x0D | 4 | 802.11 RSSI. Used to identify an IEEE 802.11 interface's received |
| | | signal strength indication (RSSI). |
| 0x0E | 0 | Icon Image. Contains an image as represented in a disk file. The |
| | | length of this property must be set to zero if it can be queried via the |
| | | QueryLargeTlv function. Other length values are not supported. |
| 0x0F | var. | Machine Name. Contains an unterminated UCS-2 string identifying |
| | | the device's host name. The maximum length of this TLV is 32 |
| | | octets. |
| 0x10 | var. | Support Information. Contains an unterminated UCS-2 string |
| | | identifying the device manufacturer's support information (e.g. |
| | | telephone number, support URL, etc.) The maximum length of this |
| | | TLV is 64 octets. |
| 0x11 | 0 | Friendly Name. Contains an unterminated UCS-2 string identifying |
| | | the device's friendly name. The length of this property must be set |
| | | to zero if it can be queried via the QueryLargeTlv function. All other |
| | | length values are not supported. |
| 0x12 | 16 | Device UUID. Used to uniquely identify a device that supports |
| | | UPnP. This TLV 1) must be identical to the UUID associated with |
| | | the device's UPnP implementation, and 2) is <*optional*> if the |
| | | device does not support UPnP. |
| 0x13 | 0 | Hardware ID. Contains an unterminated UCS-2 string used by PnP |
| | | to match the device with an INF file contained on a Windows ® PC. |
| | | The length of this property must be set to zero if it can be queried via |
| | | the QueryLargerTlv function. All other length values are not |
| | | supported. |
| 0x14 | 4 | QoS Characteristics. Used to identify various QoS-related |
| | | characteristics of the Responder host and network interface. Note, |
| | | this TLV is <*optional*>. |
| 0x15 | 1 | 802.11 Physical Medium. Used to identify the wireless physical |
| | | medium. Note that this applies to 802.11 interfaces only. |
| 0x16 | 0 | AP Association Table. Used to identify the wireless hosts |
| | | associated with an access point. The length of this property must be |
| | | set to zero if it can be queried via the QueryLargeTlv function. All |
| | | other length values are not supported. |
| 0x18 | 0 | Detailed Icon Image. This TLV is optional, although it is highly |
| | | recommended that you also make the Large Icon TLV (0x0E) |
| | | available in the presence of this TLV. The length of this property |
| | | must be set to zero if it can be queried via the QueryLargeTlv |
| | | function. All other length values are not supported. Note, this TLV is |
| | | <*optional*>. |
| 0x19 | 2 | Sees-list Working Set. Identifies the maximum entry count in the |
| | | Responder's sees-list database. Note, this TLV is <*optional*>. |
| 0x1A | 0 | Component Table. This TLV is used by multifunction devices such |
| | | as APs to report their internal components. The Mapper uses this |
| | | information to generate a more accurate topology map. The length |
| | | of this property must be set to zero if it can be queried via the |
| | | QueryLargeTlv function. All other length values are not supported. |

The TLVs below describe the properties of the responder device, including an End-Of-Property list marker, represented in FIG. 15 (type=0x00), which comprises a property that marks the end of the TLV list and thus needs to exist in a valid Hello frame. Shown in FIG. 16 is a Host ID (Type=0x01 Length=6), comprising a property that provides a way to uniquely identify the host on which the responder is running. On a host with multiple network interfaces, this may be the lowest Ethernet address across these interfaces.

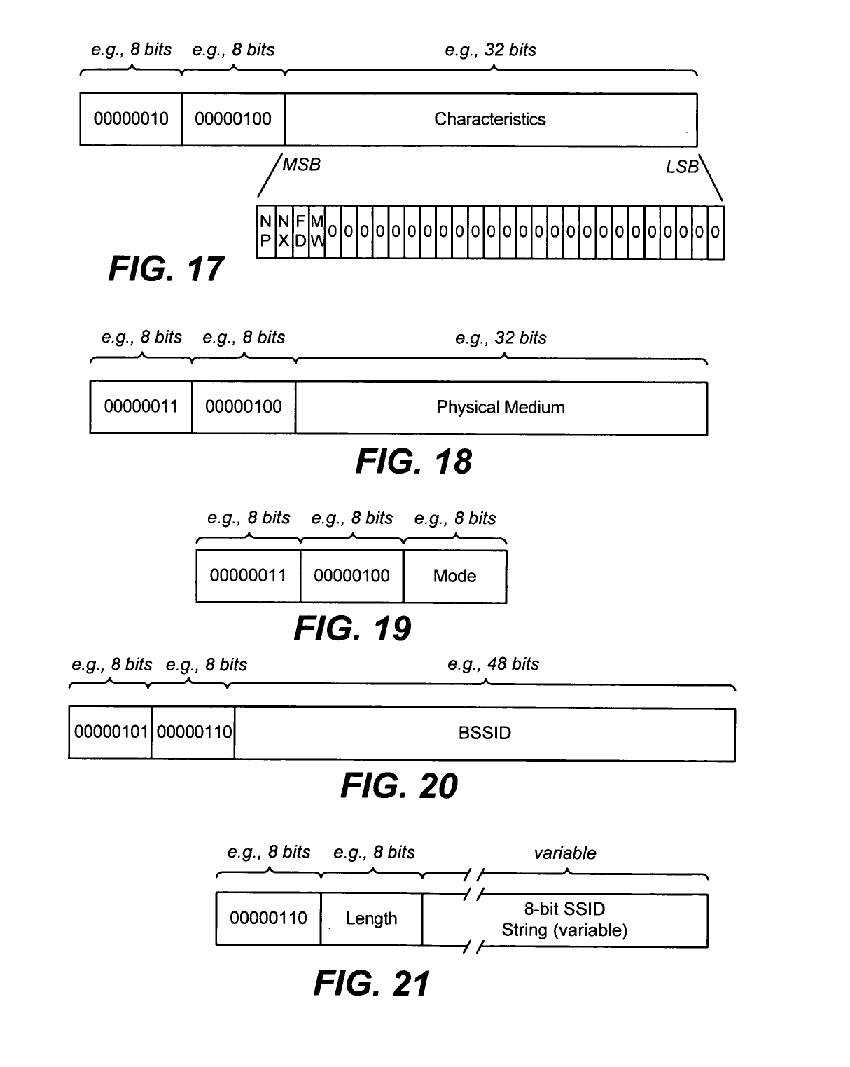

The characteristics property, represented in FIG. 17 (Type=0x02 Length=4), allows a responder to report various simple characteristics of its host or the network interface it is using. As represented in FIG. 17, bits 0-27 are reserved, and are zero in this version. Bit 28, labeled as MW, when set to one means that the device has management web page accessible via HTTP protocol. The mapper constructs a URL from the reported IPv6 address. If one is not available, the IPv4 address is used instead. The URL is of the form: http://<ip-address>/. Bit 29, labeled FD when set to one means that the interface is in full duplex mode. Bit 30, labeled (NX), when set to one means that the interface is NAT-private side. Bit 31, labeled NP, when set to one means that the interface is NAT-public side.

FIG. 18 (Type=0x03 Length=4) represents a physical medium property that allows a responder to report the physical medium type of the network interface it is using. The values are published by an Internet Assigned Numbers Authority (IANA) for the iftype object defined in MIB-II's iftable. Examples of interesting values include six (6) for Ethernet and seventy-one (71) for Wireless 802.11.

FIG. 19 (Type=0x04 Length=1) represents the wireless mode property that allows a responder to identify how its IEEE 802.11 interface connects to the network. Valid values include 0x00 for IBSS or ad hoc mode, 0x01 for infrastructure mode and 0x02 for unknown mode.

An 802.11 BSSID property is represented in FIG. 20 (Type=0x05 Length=6), and allows a responder to identify the media access control (MAC) address of the access point that its wireless interface is associated with. An 802.11 SSID property, represented in FIG. 21, (Type=0x06), allows a responder to identify the service set identifier (SSID) of the BSS with which its wireless interface is associated. Note that the string is NOT null-terminated and is case sensitive; in one implementation the maximum length of the string is 32 characters. This TLV complements the existence of the 802.11 BSSID TLV (0x05).

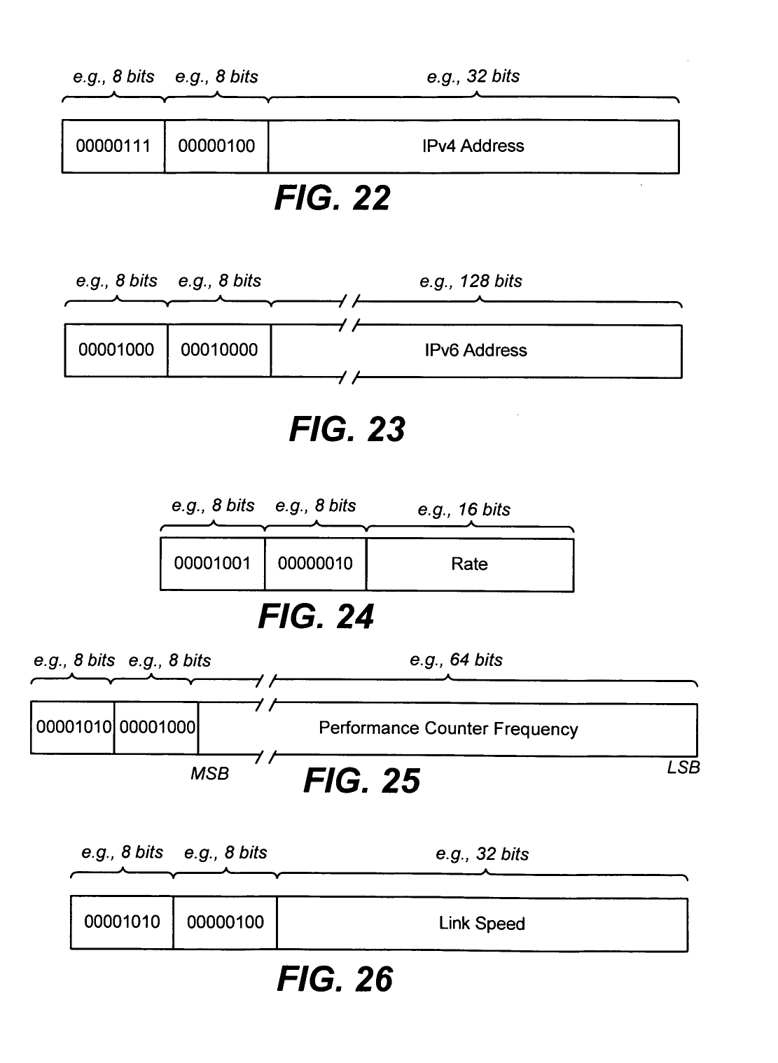

An example IPv4 Address property is represented in FIG. 22 (Type=0x07 Length=4), and allows a responder to report its most relevant IPv4 address, if available. An IPv4 address is considered to be most relevant if it satisfies one of the following conditions, in order of decreasing priority:
1. When there is more than one address available, the first public address found is the most relevant.
2. When there is more than one address available, but none of which are public, the first address in the list is the most relevant.
3. There is just one address to choose from.

An example IPv6 Address property is represented in FIG. 23 (Type=0x08 Length=16). This property allows a responder to report its most relevant IPv6 address, if available. An IPv6 address is considered to be most relevant if it satisfies one of the following conditions, in order of decreasing priority:
1. When there is more than one address available, the first global address found is the most relevant.
2. When there is more than one address available, but none of which are global, the first site-local address found is the most relevant.
3. When there is more than one address available, but none of which are global or site-local, the first link-local address found is the most relevant.
4. When there is just one address to choose from, or there are more than one address available, but none of which are global, site-local or link-local, the first address found in the list is the most relevant.

FIG. 24 represents a data structure for containing the 802.11 maximum operational rate. This property allows a responder to identify the maximum data rate at which the radio can run on its 802.11 interface. In one implementation, the data rate is encoded in units of 0.5 megabits per second (Mbps).

FIG. 25 represents a data structure for a performance counter frequency property, which allows a Responder to identify how fast its timestamp counters run, e.g., in ticks per second. This information is useful for deciphering results from timed probe and probegap tests in the QoS diagnostics type of service. The link speed property of FIG. 26 allows a responder to report the maximum speed of its network interface, e.g., in units of 100 bps.

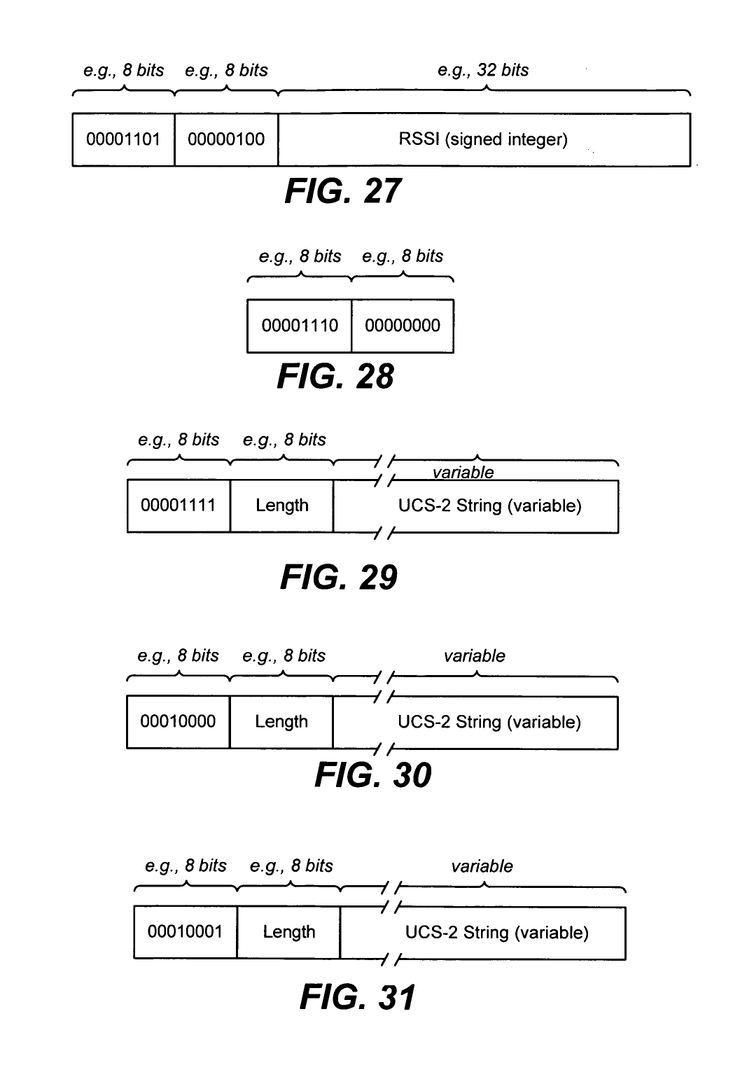

FIG. 27 represents an 802.11 RSSI property that allows a responder to identify the IEEE 802.11 interfaces' received signal strength indication (RSSI). The RSSI is measured in dBm. The normal range for the RSSI values is from −10 through −200.

An icon image property is represented in FIG. 28, and may contain an icon image representing the host running the responder. In one implementation, the data returned is as it would be represented in a disk file. One supported icon image format is ICO (Windows® icon format), in which the icon dimension should be at least 48 pixels wide by 48 pixels tall. Icons should also make use of the built-in transparency support. Note that this is a large TLV. FIG. 29 represents a machine name property that contains the device's host name. Note that in this example the string is not null-terminated; the maximum length of the string is 16 characters or 32 octets. A support information property is represented in FIG. 30, and contains the device manufacturer's support information (e.g., telephone number, support URL, and so forth). Note that an Internet URL may be filtered such that the user will not see it, and thus should not be used. Further, note that in this example the string is not null-terminated; the maximum length of the string is 32 characters or 64 octets. A friendly name property is represented in FIG. 31, and in general is only used by computer devices. It contains the friendly name or description assigned to the computer. Note that in this example the string is not null-terminated; the maximum length of the string is 32 characters or 64 octets.

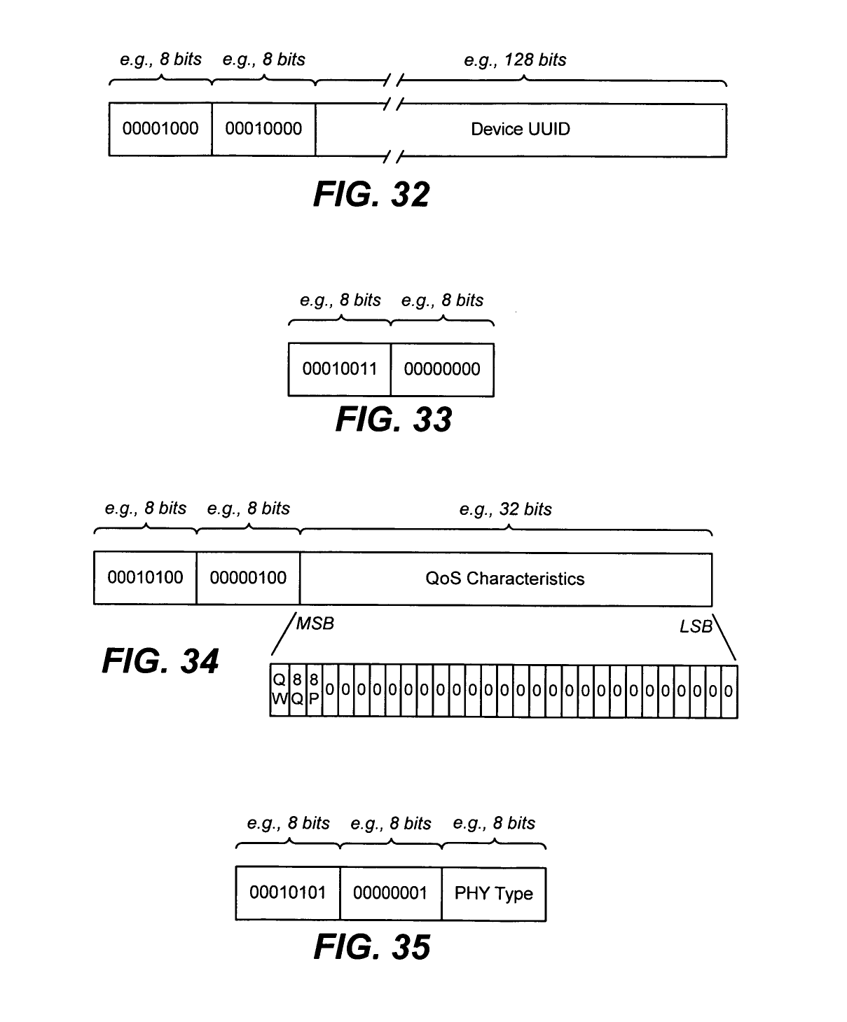

FIG. 32 is for the device UUID property, which returns the UUID of a device that supports UPnP (Universal Plug-and-Play). The Device UUID is essentially the same UUID found in the device Unique Service Name (USN) portion of a SSDP discovery response.

A hardware ID property, represented in FIG. 33 as a large TLV, comprises the string used by PnP to match a device with an INF file contained on a Windows®-based personal computer. For a UPnP device, the information needed comes from the UPnP device description phase which has the XML elements that PNP-X uses to derive the PnP Hardware ID string. The hardware ID needs to follow the formatting rules currently used by Windows® PnP:
1. Characters with ASCII value less than 0x20 are not allowed.
2. Characters with ASCII value greater than 0x80 are not allowed.
3. Commas are not allowed.
4. Spaces ‘ ’ need to be replaced with an underscore character ‘_’.
   Note that the string is NOT null-terminated; the maximum length of the string is 200 characters or 400 octets and is stored in UCS-2 format.

A QoS Characteristics property is represented in FIG. 34, and allows a responder to report various QoS-related characteristics of its host or the network interface it is using. In one version, bits 0-28 are reserved and set to zero. Bit 29 (labeled 8P), when set to one (1), denotes that the interface supports 802.1p priority tagging. Bit 30 (labeled 8Q), when set to one (1), denotes that the interface supports 802.1q VLAN tagging. Bit 31 (labeled QW) indicates that the Interface is qWave-enabled when set to one (1).

The 802.11 Physical Medium property represented in FIG. 35 allows a responder to report the 802.11 physical medium in use. Valid values include:
0x00—Unknown
0x01—FHSS 2.4 GHz
0x02—DSSS 2.4 GHz
0x03—IR Baseband
0x04—OFDM 5 GHz
0x05—HRDSSS
0x06—ERP
0x07 through 0xFF—Reserved for future use

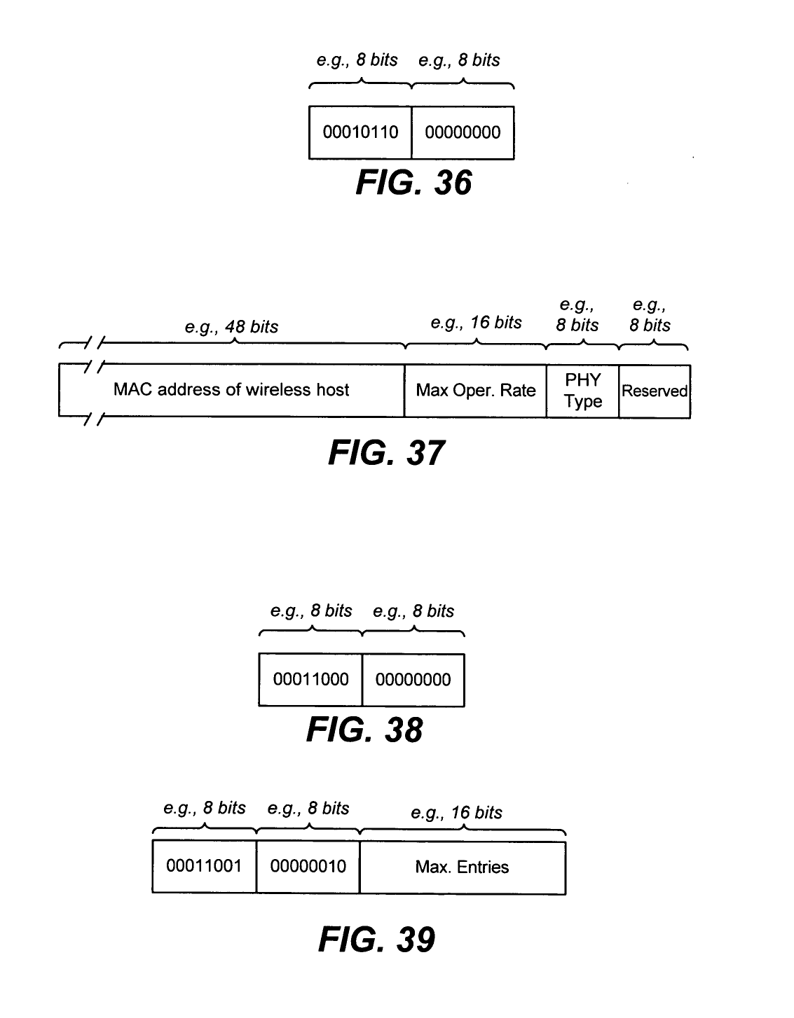

The AP association table property represented in FIG. 36 allows an access point to report the wireless hosts that are associated with it. This information is useful for discovering legacy wireless devices that do not implement the responder. Additionally, it allows the mapper to conclusively match wireless hosts associated to the same access point via different BSSIDs (e.g. one for each supported band). This is a large TLV; each table entry is 10-octets long and has the format represented in FIG. 37, including the MAC address of wireless host, and a maximum operational rate that describes the maximum data rate at which the selected radio can run to the given host. For example, the data rate may be encoded in units of 0.5 megabits per second (Mbps). The PHY type (Physical Medium Type) field describes the physical medium selected for the given host. Valid values include:
0x00—Unknown
0x01—FHSS 2.4 GHz
0x02—DSSS 2.4 GHz
0x03—IR Baseband
0x04—OFDM 5 GHz
0x05—HRDSSS
0x06—ERP
0x07-0xFF—Reserved for future use
   The reserved field following the PHY type field is set to zero in this version.

FIG. 38 represents a property that contains detailed icon image data, and is similar to the above-described icon image property (of FIG. 28). In one implementation, the maximum size of this property is 262144 octets; it enables good coverage of resolutions larger than the standard 48 by 48 pixels. Note that if this TLV is available with a responder, the smaller icon image TLV should also be available, because the mapper may choose to use only one of these TLVs based on the size of the network.

A Sees-list Working Set property (FIG. 39) allows a responder to report a maximum count of RecveeDesc entries that may be stored in its sees-list database. Embedded devices with limited memory resource are good candidates for returning this property.

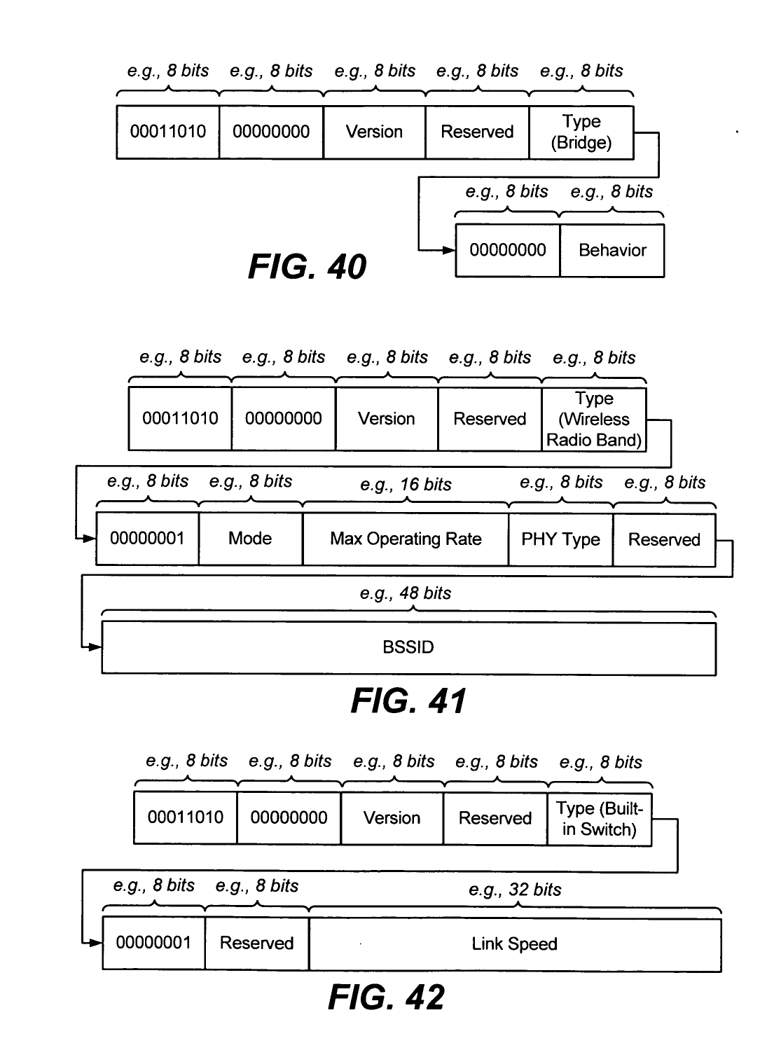

FIGS. 40-42 represent a component table, comprising a property is used to identify the components in a multifunction device; this is a large TLV. The table begins with a 2-octet long header for version and reserved fields, set to one (1) and zero (0) respectively in this version. As also represented in FIGS. 40-42, this header is followed by an arbitrary number of component descriptors, each carrying a type header, where type identifies the component type. Valid values include:
0x00—Bridge interconnecting WLAN and LAN segments. It is assumed that the responder reporting the component table TLV (FIG. 40) is connected directly into this bridge.
0x01—Wireless radio band (FIG. 41).
0x02—Built-in switch (FIG. 42). If a bridge component (type 0x00) exists, it is assumed that this switch connects directly into the bridge. If a bridge does not exist, the switch is assumed to connect directly to the built-in Responder.
Components not defined through the type enumeration above do not have to be reported.

A bridge component descriptor with type value 0x00 has the format represented in FIG. 40, with a behavior field that identifies the behavior of the bridge. Valid values include:
0x00—Hub: all packets transiting between LAN and WLAN are seen on Responder.
0x01—Switch: packets from LAN or WLAN are only seen on Responder if they are broadcast or explicitly targeted at the Responder.

A wireless radio band component descriptor with type value 0x01 has the format represented in FIG. 41, with a mode field containing data that identifies how the radio connects to the wireless network. Valid values include:
0x00—IBSS or ad hoc mode
0x01—Infrastructure mode
0x02—Unknown mode

A maximum operational rate field identifies the maximum data rate at which the radio can run. The data rate is encoded in units of 0.5 megabits per second (Mbps).

The PHY type (Physical Medium Type) field describes the physical medium selected. Valid values include are:
0x00—Unknown
0x01—FHSS 2.4 GHz
0x02—DSSS 2.4 GHz
0x03—IR Baseband
0x04—OFDM 5 GHz
0x05—HRDSSS
0x06—ERP

Also shown in FIG. 41, is the Reserved field, set to zero in this example version. The Link Speed field reports the link speed of the medium, and the BSSID field identifies the media access control (MAC) address used by the radio band.

As represented in FIG. 42, a built-in switch component descriptor with type value 0x02 has another format. the Reserved field is set to zero in this example version, and the Link Speed field reports the maximum speed of the switch, e.g., in units of 100 bps.

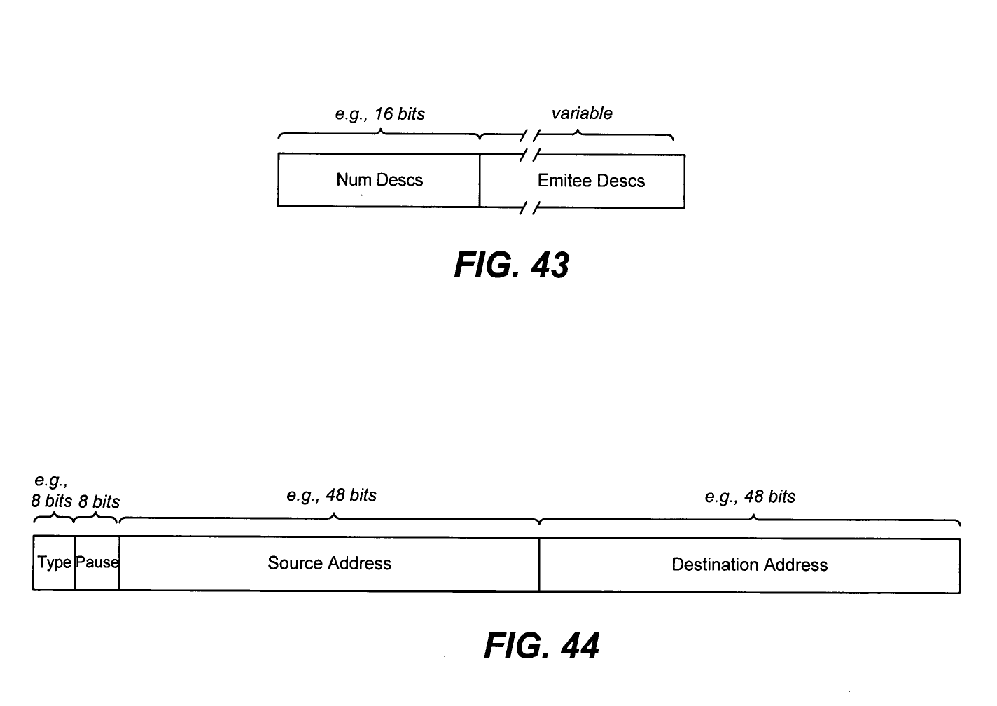

As generally described above with respect to the emit upper-level header format, an Emit frame comprises a list of source and destination Ethernet addresses prefixed by number of milliseconds to pause before sending a frame. An example Emit frame following a Base header (e.g., 406_{X} in FIG. 7, with the same fields as other types of base headers) is represented in FIG. 43. In this example, the Num Descs field contains the count of EmiteeDesc items following, wherein each EmiteeDesc item comprises a 14-octet structure represented in FIG. 44. in this example, a single Emit frame has space to contain up to a maximum of 105 EmiteeDesc structures, since it fits into a 1514 octet Ethernet frame, however a lower constraint comes from the maximum charge:

$$\begin{matrix}1514 - \\ 14 ( Ethernet header ) - \\ 4 ( Demultiplex header ) - \\ 14 ( Base header ) - \\ 2 ( Emit header ) \\ 1480 / 14 octets per EmiteeDesc structure , = 105 EmiteeDesc structures .\end{matrix}$$

In the example EmiteeDesc Header of FIG. 44, the type field identifies the type of packet to emit. Valid values include:
0x00—Train
0x01—Probe

The Pause field identifies a time (e.g., number of milliseconds) to pause before the associated packet is emitted. In one example implementation, the cumulative pause value from all EmiteeDesc entries in an Emit frame cannot exceed one second or the responder will drop the entire Emit request.

The source address field identifies the source Ethernet address of the packet to emit. The real source address of the packet is the address of the responder itself. The source address is restricted to either the host's own normal Ethernet address, or a specially allocated OUI.

The destination address field identifies the destination Ethernet and Real destination addresses of the packet to emit. The destination address may not be a broadcast or multicast address, as these could amplify traffic.

Other types of frames include train frames, probe frames and ACK frames. Train frames are only used to train switches, and are discarded by responders. The train frame does not have an upper-level header beyond the base header itself.

Responders whose topology state engine is in Command state add Probe frames that they receive to their “sees” array, noting the Probe's Ethernet source and destination addresses, and Real Source address from the Base header. The Probe frame does not have an upper-level header beyond the Base header itself.

ACK frames are not acknowledged, however the sequence number field in the base header is non-zero, i.e. the sequence number of the request which is being acknowledged. The ACK frame does not have an upper-level header beyond the Base header itself.

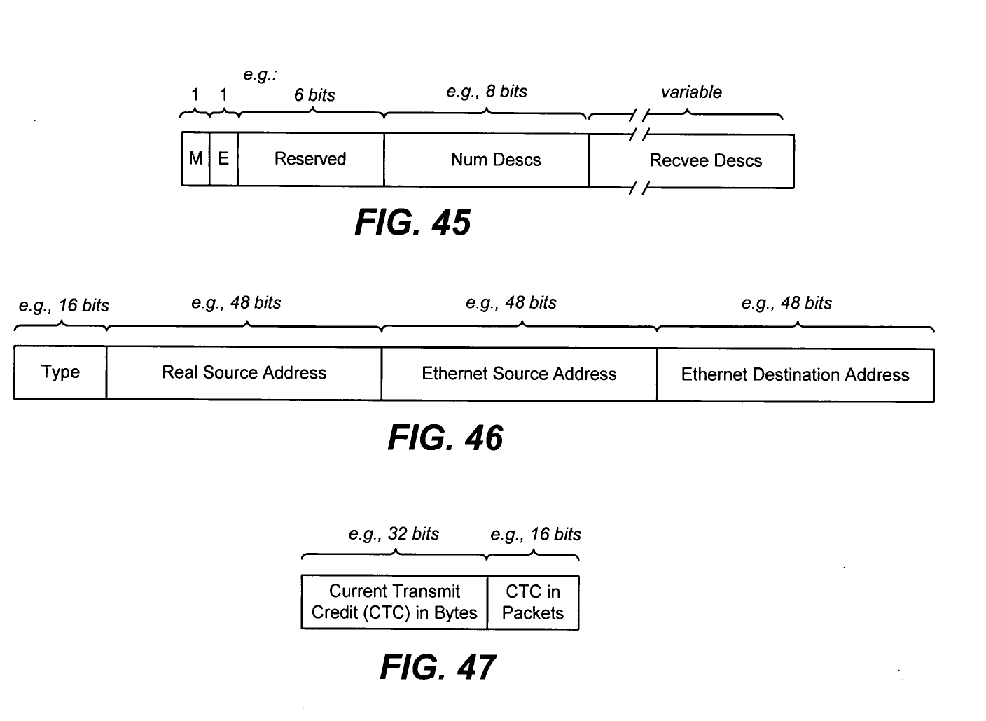

The Query frame does not have an upper-level header beyond the base header itself. However, the response to a query (QueryResp) does have an upper-level header format, an example of which is represented in FIG. 45. QueryResp lists which recordable events (e.g. Ethernet source, and Ethernet destination addresses) have been observed on the wire since the previous Query; (Query removes reported events from the Responder's topology mapping engine's internal list).

QueryResp frames are not ACKed, but set the Base header's sequence number field to match the Query they are generated in response to. Responders sending this frame cannot merge identical recordable events (RecveeDescs) even if they occur multiple times. The ordering of RecveeDesc items in this frame should represent arrival time ordering. If there are more triples than will fit in one frame, “num descs” has its top (M) bit set to indicate that further pairs will follow. If the mapper receives a QueryResp with the M bit set, it should issue a fresh Query (i.e. with new sequence number) to the responder to collect additional RecveeDescs from it.

The example QueryResp header of FIG. 45 includes a one-bit ‘More’ (M) flag which when set to one (1), indicates that there are more RecveeDescs than will fit in one frame and the mapper should follow-up with another Query request. Another one-bit ‘Error’ (E) flag, when set to one (1), indicates that the responder was not able to record a RecveeDesc due to lack of memory.

The Num Descs field identifies the count of RecveeDesc structures returned, where each RecveeDesc item is a 20-octet structure, as represented in the example RecveeDesc Header of FIG. 46. In this header, the type field identifies the protocol type recorded. Valid values include:
0—Probe
1—ARP/ICMPv6 Neighbor Discovery

For ARP (Address Resolution Protocol), the real source address field corresponds to the senderhw field in an ARP response packet. For ICMPv6, the real source address field corresponds to the optional target link-layer address option in a neighbor discovery packet.

The Ethernet source and destination addresses are also included in this structure. In one example implementation, a single QueryResp frame may only contain up to a maximum of 74 RecveeDesc structures, since it needs to fit into a 1514 octet Ethernet frame:

$$\begin{matrix}1514 - \\ 14 ( Ethernet header ) - \\ 4 ( Demultiplex header ) - \\ 14 ( Base header ) - \\ 2 ( QueryResp header ) \\ 1480 / 20 octets per Recvee structure = 74 RecveeDesc structures .\end{matrix}$$

A reset frame does not have an upper-level header beyond the base header itself. A reset frame is sent by a mapper whenever it needs to abort a mapping generation, e.g., because someone else is mapping, or because mapping is over. An enumerator sends this after it is satisfied with the enumeration results.

A charge frame does not have an upper-level header beyond the Base header itself. When a Charge frame is received by a responder whose topology engine is in Command state, it increases its CTC counter by the size of the entire Charge frame, including its Ethernet header. The CTC value is capped at CTC_MAX. When CTC goes non-zero, the CTC_RESET_TIMER is started or restarted, (unless the CTC value was already capped). When the CTC_RESET_TIMER fires, CTC is zeroed.

FIG. 47 represents an example Upper-Level Header Format of a flat frame following a Base header. The CTC field contains the value of the CTC byte counter at the responder. The CTC in Packets field contains the value of the CTC packet counter at the responder.

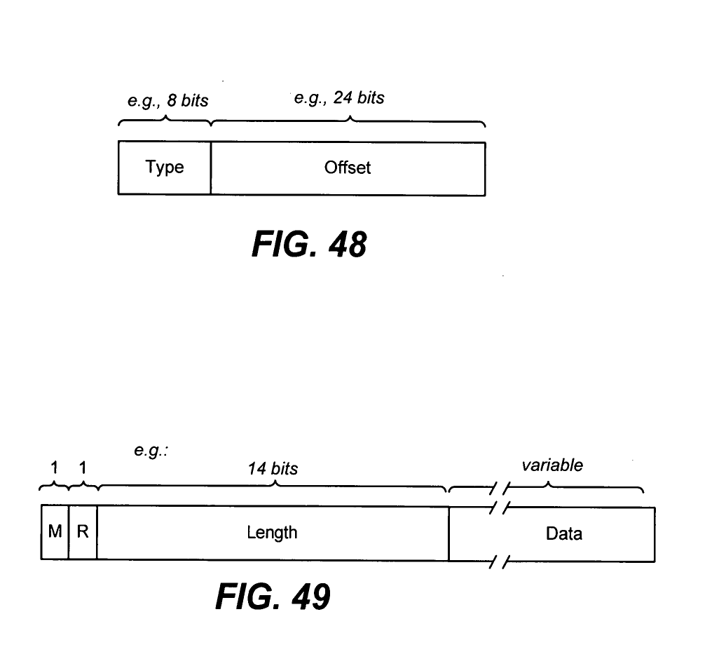

An example QueryLargeTlv upper-level header format (following a Base header) is represented in FIG. 48, by which a QueryLargeTlv frame allows the mapper to query a responder for TLVs that are too large to fit into a single Hello frame. Each QueryLargeTlv request results in at most one QueryLargeTlvResp response. Repeated QueryLargeTlv requests are made for sufficiently large TLVs that do not fit in a single QueryLargeTlvResp response frame.

The type field identifies the type of TLV that is supported. If the requested type is not one of the values below, a QueryLargeTlvResp should still be sent in response, but with the Length field set to zero.

Valid large TLVs type values include:

| Type | MaxLength | Description |
|---|---|---|
| 0x0E | 32768 | Icon Image. This TLV contains an image as represented in a disk |
| | | file. |
| 0x11 | 64 | Friendly Name. This TLV contains an unterminated UCS-2 string |
| | | identifying the device's friendly name. |
| 0x13 | 400 | Hardware ID. This TLV contains an unterminated UCS-2 string |
| | | used by PnP to match the device with an INF file contained on a |
| | | Windows ® PC. |
| 0x16 | 4096 | AP Association Table. This TLV contains a table identifying the |
| | | wireless hosts that are associated with it, along with various other |
| | | information. |
| 0x18 | 262144 | Detailed Icon Image. This TLV contains an icon image that may be |
| | | significantly more detailed than that returned by the Icon Image |
| | | TLV. |
| 0x1A | 4096 | Component Table. This TLV is used by multifunction devices such |
| | | as APs to report their internal components. The Mapper uses this |
| | | information to generate a more accurate topology map. |

The Offset field describes the offset in octets within the TLV data to query.

A QueryLargeTlvResp frame (FIG. 49) is a response to a QueryLargeTlv request. It returns the maximum relevant octets that would fit into a response frame over the Ethernet media from a requested offset. In the case where a QueryLargeTlv is for an unsupported TLV type, a QueryLargeTlvResp frame must be sent with the Length field zeroed. The QueryLargeTlvResp header immediately follows the Base header; an example QueryLargeTlvResp header format is represented in FIG. 49.

In FIG. 49, the ‘More’ (M) flag comprises a one-bit field that when set to one (1) indicates that there is more data than will fit in one frame, and the mapper should follow-up with a QueryLargeTlv request at the next logical offset. The ‘Reserved’ (R) flag is a one-bit field set to zero in this version. The length field identifies the octet count of data returned in the QueryLargeTlvResp frame.

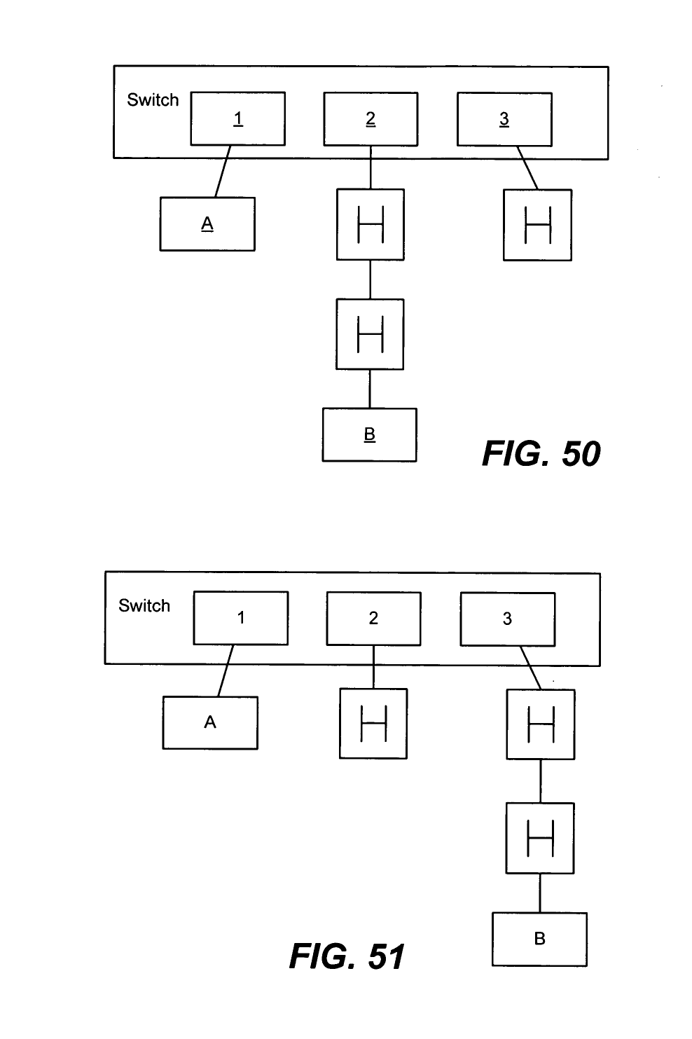

Turning to a consideration of Hello frames, consider an example two machines communicating with one another using their own real MAC addresses. Suppose machines A and B communicate using IP and in a fashion in which A sends a query to B and B replies and neither A nor B sends other traffic. In the example of FIG. 50, machine A is directly attached to a switch port 1, and B indirectly attached via hubs to a switch port 2. As exemplified in FIG. 51, the machine B is moved to port 3.

In a scenario without the hubs, machines A and B manage to continue to communicate if B is moved, in a number of possible ways. For example, consider that the machine B was directly attached to port 2 (that is, without the Hubs in FIG. 50), and moved to be attached to port 3, (that is, without the hubs in FIG. 51). One alternative is that the switch may see the link go down, whereby the switch will forget the addresses it had learned on that port; subsequently the switch will flood packets with a destination of B so B will get them. Once B sends a packet, the switch knows where B is and stops flooding, and B is known to be attached to port 3. Alternatively, if the machine B was directly attached to the port 2 originally, the machine may see the link go down. When the machine B sees its NIC get reconnected, it sends a DHCP request to make sure it is still on the same IP subnet and can still use the same address. This packet will cause the switch to know where B is, whereby communication will resume as normal.

Now consider the example of FIG. 50 where B is not directly connected to port 2, but rather there are two hubs between B and port 2. If machine B and the hubs are reconfigured such that the network goes to the configuration of FIG. 51, neither the switch nor machine B will see a link disconnect/connect, so the switch will not flush its address table, nor will machine B send a DHCP broadcast. In such a scenario, requests from A to B will get lost, until eventually the switch times out its address entry associated with machine B and subsequent requests will get flooded (or A times out of its ARP cache entry for B and sends a broadcast ARP request which B will get and respond to; B's response will then train the switch as to where B is).

Thus, at the start of a topology discovery mapping, to ensure that every switch in the network knows the true location of every real address in the network, responders broadcast their responses. Wireless devices similarly do a MAC-level NAT, because the only way to be sure to get through the NAT is to broadcast.

Note that Emit messages are not always acknowledged. For example, in many typical usages the Emit command carries a single command to emit a single Probe that travels to some other responder in the network. From the point of view of the mapper analyzing the network, it is much more concerned about whether the probe arrives than whether the probe was transmitted. Therefore it can check that the probe was transmitted by issuing a Query to the destination responder. An unacknowledged Emit is more efficient in that it avoids not only the acknowledgement, but also the Charge for the acknowledgement; when sending a single Probe the Emit carries enough charge on its own.

Note that the responder keeps a list of probe packets it has seen instead of reflecting the probe packets when they arrive to the Mapper. One reason for this is scalability, in that many times probe packets are flooded over a portion (or all) of the network; if every responder to see a probe were to reflect it to the Mapper then on a large network there would be a huge implosion at the Mapper and very high network load. Another reason is reliability, in that the current protocol is designed so that the reliable communication between mapper and responder is very simple; if responders were sending reflections then there would be a huge bunch of complexity associated with whether the probe got lost between the sender and the responder, or the reflection between the responder and the mapper.

Turning to a consideration of the QoS Diagnostics protocol that facilitates the network test functionality, this part of the protocol may be used to determine the bottleneck bandwidth (also referred to as the capacity) of a path, the available bandwidth of a path, whether the network equipment of a path has a prioritization mechanism, and so forth.

Considering operational states, there are generally two different roles in a network test session, namely the controller and the sink (wherein in general, the sink is the responder station that is the target of a network test session). In general, the Controller manages a network test session by initializing and resetting the Sink, and sending probe packets to the Sink. Also, for timed probes, the controller queries the Sink for test result. For probegaps, the controller accepts a probe response from the Sink. A responder implements only the Sink functionality.

Each Network Test session may operate in an initialization scenario in which the Controller initializes the Sink, e.g., by sending a QosInitializeSink frame to the Sink. The Sink acknowledges the request and agrees to the assigned role by sending a QosReady frame. Otherwise, the Sink sends a QosError frame.

In an Emit scenario, the Controller emits probe frames to the Sink, by sending one or more QosProbe frames from the Controller to the Sink. In one implementation, a limited number (e.g., no more than 82) of consecutive QosProbe frames will be sent in this mode. In a probegap test, a QosProbe frame received at the Sink is reflected back to the Controller, with the appropriate timestamps applied. In a timed probe test, the Sink records the QosProbe frames that it sees, but does not respond.

In a Query scenario, the Controller queries for test results by sending a QosQuery frame to the Sink in a timed probe test. A QosQueryResp is sent back to the Controller with the test results.

In one implementation, each network test session is identified by the MAC address of the controller station. Depending on the type of test requested, (e.g., probegap or timed probe), a session may have to dynamically allocate more memory to support the operation. The type of test performed over a network test session may be arbitrary and is indicated by the ‘Test Type’ field in a QosProbe packet.

A probegap test requires that a Sink copy a received packet payload as-is and send it back to the source along with the appropriate quality-of-service specification (e.g., 802.1 p tagging). This type of experiment does not impose additional memory requirement on a network test session.

A timed probe test requires that a sink component receive and record some number (e.g., up to 82) consecutive QosProbe packets (‘Test Type’ field set to 0x01) of the same sequence number. The sink records specific bits of information from each packet, e.g., in the form of an 8-octet high-resolution timestamp of the send operation on the Controller side, an 8-octet high-resolution timestamp of the receive operation on the Sink side, and a 1-octet identifier. This recorded information is requested by the controller after the last QosProbe is sent via the QosQuery frame. Note that in one implementation, only one timed probe test (comprised of a series of more than one QosProbe frames) may be performed for a network test session at any instance in time.

Memory may need to be allocated dynamically for the timed probe test. If a device does not have the memory to allocate the 82-entry storage table up front, it may split the allocation into multiples of 24-entry segments. In case of memory allocation failure, the sink should report the error condition in the QosQueryResp packet.

For network load control, a Sink supports some number (e.g., at least three) unique network test sessions up to some recommended maximum of (e.g., ten) sessions. If a Sink cannot support additional sessions, it returns the QosError frame along with a valid error code. In an alternative implementation, if the number of unique network test sessions supported per Sink is exceeded, subsequent QosInitializeSink solicitations from unassociated Controllers are dropped.

If a QosInitializeSink is received for an existing network test session, the QosReady frame is sent in response.

Network test sessions may expire after some amount (e.g., at least thirty seconds) of inactivity. In the case where timers are expensive resources, the use of one global recurring timer to service existing sessions is recommended. Such a timer should operate at a maximum fixed interval of thirty seconds.

The following frames need to reset the inactivity timer for the relevant session:

| Function | Note |
|---|---|
| QosInitializeSink | Only if QosInitializeSink is received for an |
| | existing Network Test session. |
| QosQuery | N/A |
| QosProbe | Only if Test Type field in QosProbe frame is 0x01. |

Reliability is ensured by using sequence numbers (i.e. the Identifier field in the Base header) in Controller requests, and having the Sink quote this value in any response packet. The request/response pairs are:

| Controller | Sink |
|---|---|
| QosInitializeSink | QosReady/QosError |
| QosProbe | QosProbe (only probegap test) |
| QosQuery | QosQueryResp |
| QosReset | QosAck |

The following table shows which function types are allowed to be sent to the broadcast address, which may have a non-zero sequence number, and which are required to have a non-zero sequence number:

| Function | Value | Broadcast? | Sequence? |
|---|---|---|---|
| QosInitializeSink | 0x00 | No | Required |
| QosReady | 0x01 | No | Required |
| QosProbe | 0x02 | No | Permitted |
| QosQuery | 0x03 | No | Required |
| QosQueryResp | 0x04 | No | Required |
| QosReset | 0x05 | No | Required |
| QosError | 0x06 | No | Required |
| QosAck | 0x07 | No | Required |

A session identifier is used with a network test session that is identified by the network address of the Controller and Sink stations. In order for a network test frame to be properly associated with the correct session, both addresses need to be known. This can be achieved by examining the network address fields in the Base header.

For sequence number management, a sequence number is a value (e.g., contained in a 16 bit field) used with commands and requests. Note that commands and requests from the Controller to the Sink may have no sequence number (in which case the field is zero) or may be sequenced in which case they have a non-zero sequence number. Sequence numbers are advanced using increment in ones-complement arithmetic; that is, they advance from 0xFFFF to 0x0001 and skip 0x0000.

The first sequence number of a test session, introduced in the QosInitializeSink frame, is taken by the responder and subsequent sequence numbers must have the correct value (either a retransmission which is re-acknowledged as mentioned above, or the successor value). The QosProbe frame uses a loosely managed sequence numbering system. In other words, the Sink will not enforce the validity of the sequence number. The Controller uses this number to correlate and validate QosProbe frames it sends and receives in a probegap experiment.

The base header format for network test is the same as previously represented in FIG. 7, that is, the header 406_{X} has the same fields for network test as with other uses for the base header. The real source and destination Ethernet addresses are set by a sender to its own Ethernet address and its intended destination Ethernet address respectively; these fields are needed because the source and destination address fields of the Ethernet header are rewritten by some network devices and thus may not survive an end-to-end transmission. The sequence number ensures reliability of certain packets in the protocol. Note that while the frames in this protocol have a sequence number field, it needs to be zero in some cases. For function codes 0x07 and 0x08, this field needs to be non-zero.

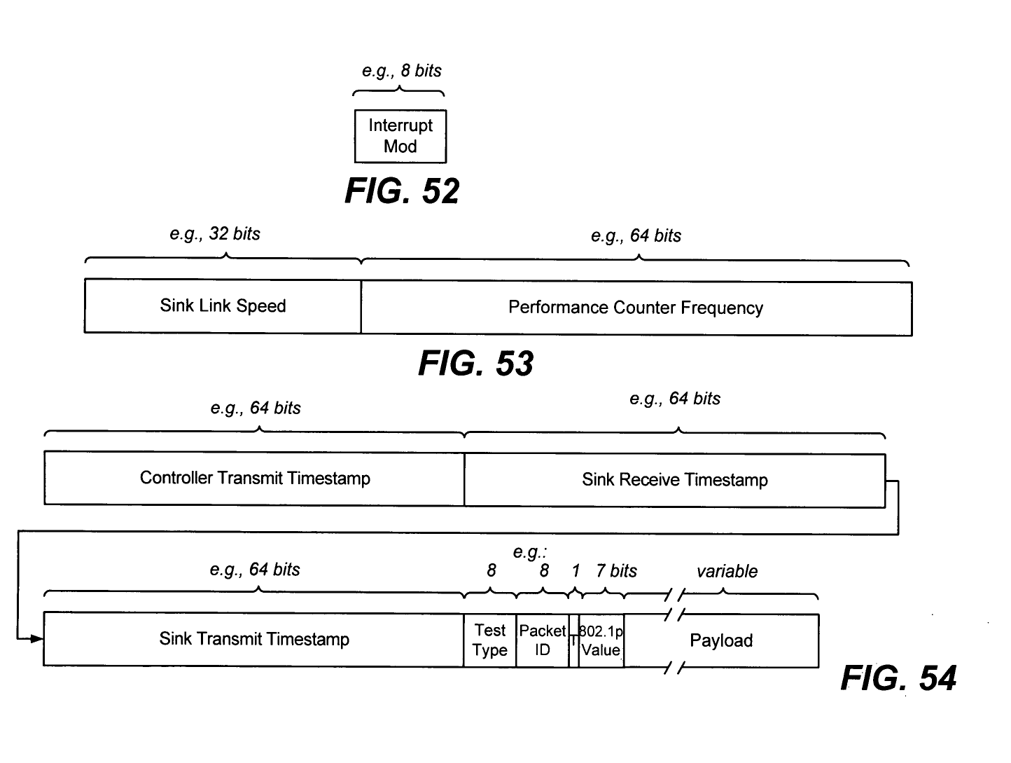

An example QosInitializeSink upper-level header format is represented in FIG. 52, where a QosInitializeSink frame is sent to the Sink to set up a Network Test session. The ‘Interrupt Mod’ (I) flag is set to indicate the interrupt moderation need of a Network Test session as follows:
0x00=Disable interrupt moderation
0x01=Enable interrupt moderation
0xFF=Use existing interrupt moderation setting

Where applicable, the following error codes are used in the resulting QosError response:
0x01=Insufficient resources
   Responder ran out of resources attempting to set up the session.
0x02=Busy; try again later
   Responder has reached its session limit.
0x03=Interrupt moderation not available
   Interrupt moderation need cannot be satisfied or the ability to control it is not available.

A QosReady frame is sent in reply to QosInitializeSink, to confirm the creation or existence of a Network Test session. Note that a QosReady frame is sent even if the Network Test session already exists. An example QosReady header following a base header is represented in FIG. 53. in this example, the Sink Link Speed field allows a responder to report its link speed, e.g., in 100 bits-per-second units. The performance counter frequency field allows a responder to identify how fast its timestamp counters run, e.g., in ticks per second.

A QosProbe should be timestamped on transmission, and again when received. Responders receiving QosProbe frames should log to their event list the two timestamps, ready to report them in a subsequent QosQueryResp. In the case of probegap analysis, a QosProbe frame is transmitted by the Controller, received by the Sink and then transmitted by the Sink back to the Controller. The frame is timestamped by the Controller, timestamped by the Sink when received and again when transmitted back to the Controller. The Controller makes a final timestamp when it receives the QosProbe packet from the Sink.

In the case of timed probe analysis, up to 82 consecutive QosProbe frames may be sent by the Controller. This represents the maximum number of records that may be returned in a single QosQueryResp frame. Sequence numbering is only used for probegap test type.

An example QosProbe header following base header is represented in FIG. 54. In this example header, the controller transmit timestamp field contains the timestamp of the Controller on transmission, e.g., in vendor-specified units. The measurement unit used is specific to the Controller host. The sink receive timestamp field is zeroed in a timed probe test. In a probegap test, this field is zeroed on transmission from the Controller, and contains a valid timestamp on transmission from the Sink in vendor-specific units as declared by QosReady. The sink transmit timestamp field is zeroed in a timed probe test. In a probegap test, this field is zeroed on transmission from the Controller, and contains a valid timestamp on transmission from the Sink in vendor-specific units as declared by QosReady.

The test type field specifies the test type in which this packet is involved:
0x00=Timed Probe
0x01=Probegap originating from Controller.
0x02=Probegap originating from Sink.

The packet ID field is an application-specific identifier given to the Controller. The ‘802.1 p Value’ (T) flag is a one-bit field that specifies the presence of the following 802.1p value in the 802.1q tag for each packet. The 802.1p value field specifies the 802.1p value to be included in the 802.1q tag for each QosProbe packet that gets reflected back to the Controller in the case of a probegap test.

The payload is a variable length field in which the meaning of the payload data is specific to the Controller. In a probegap experiment, the payload content is duplicated on the Sink's send path.

The QosQuery frame does not have an upper-level header beyond the Base header itself. It has non-zero sequence number. However, the QosQueryResp frame is the response to a QosQuery, and lists QosProbe events (also referred to as QosEventDesc structures) that have been observed since the previous QosQuery. QosQueryResp frames are not acknowledged, but do set the Base header's identifier field to match the QosQuery they are generated in response to. The ordering of QosEventDesc items in this frame should represent arrival time ordering.

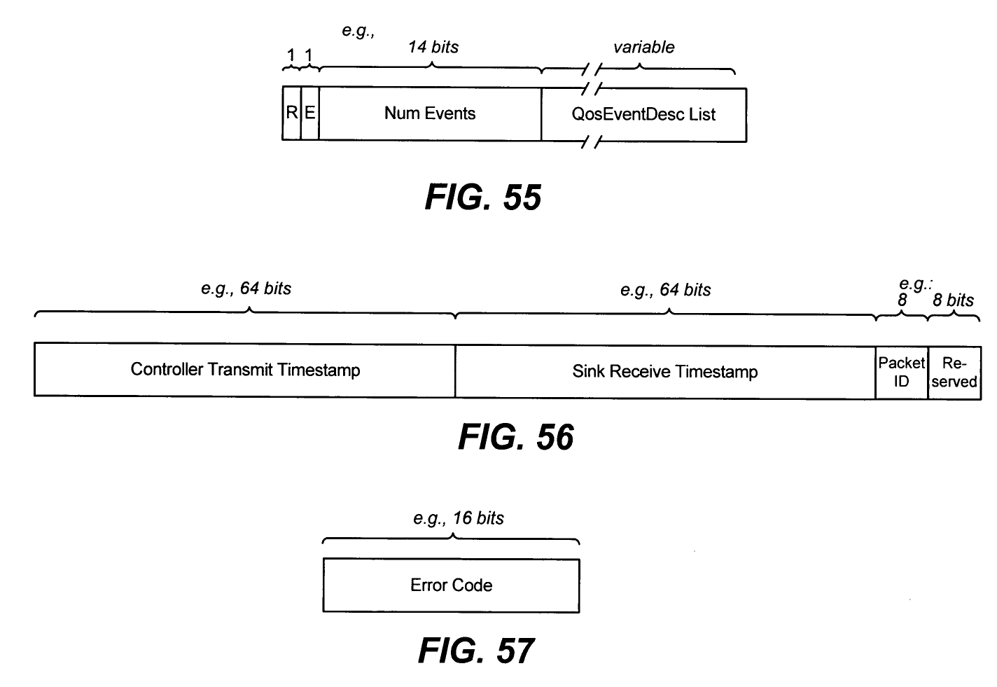

An example QosQueryResp header (following a base header) is represented in FIG. 55. In this example, a ‘Reserved’ (R) flag comprises a 1 bit field set to zero in this version, and a 1-bit ‘Error’ (E) flag field, which if set indicates that the responder was not able to allocate enough memory for one or more QosEventDesc structures. In this case, the ‘Num Events’ field should be zero and no QosEventDesc structures should follow. The Num Events field identifies the count of QosEventDesc items to follow.

The QosEventDesc list is a variable length field, in which each QosEventDesc item is an 18-octet structure in this example, as represented in the example QosEventDesc Header of FIG. 56. In FIG. 56 the controller transmit timestamp field contains the timestamp of the Controller on event transmission, e.g., in vendor-specific units. The measurement unit used is specific to the Controller host. The sink receive timestamp field contains the timestamp of the Sink on event reception, e.g., in vendor-specific units, as declared by QosReady. The Packet ID field corresponds to the Packet ID field from a QosProbe frame that generated the event. The reserved field is not currently used; it does pad the structure to an even size, however.

A single QosQueryResp frame may only contain up to a maximum of 82 QosEventDesc structures, since it must fit into a 1514 octet Ethernet frame:

$$\begin{matrix}1514 - \\ 14 ( Ethernet header ) - \\ 4 ( Demultiplex header ) - \\ 14 ( Base header ) - \\ 2 ( QosQueryResp header ) \\ 1480 / 18 octets per QosEventDesc structure = \\ 82 QosEventDesc structures .\end{matrix}$$

A QosReset frame does not have an upper-level header beyond the Base header itself. A QosAck frame does not have an upper-level header beyond the Base header itself.

An example QosError header following the Base header is represented in FIG. 57, in which the error code field specifies an error code that identifies the reason why a request failed, resulting in this response. Valid error code values include:
0x00=Insufficient resources
0x01=Busy; try again later
0x02=Interrupt moderation not available

Turning to a consideration of QoS Diagnostics for Cross-Traffic Analysis, the QoS Diagnostics protocol also facilitates Cross-Traffic Analysis by returning per-network interface IP performance counters in an efficient manner. Participating responders are required to maintain a running history of the following counters:

| Counter | Importance |
|---|---|
| Number of bytes received | Mandatory |
| Number of bytes sent | Mandatory |
| Number of packets received | Optional |
| Number of packets sent | Optional |

Note that optional importance allows devices with limited memory to choose to record only the byte counters.

In one example, byte counts use a fixed scaling factor inclusively between 1 and 256 kilobyte units. Packet counts use a fixed scaling factor inclusively between 1 and 256 packet units. It is up to each individual implementation of the protocol to pick the scaling factors that work best for them.

The counters may be sampled at one-second intervals and each counter is measured relative to that from the previous interval. In this example, at least three seconds worth of history is maintained for each counter, although for devices that have sufficient memory, it is recommended that they collect up to thirty seconds worth of history.

Hereinafter, the four counters existing in any one-second interval will be referred to as the ‘4-tuple’; function codes 0x07 through 0x09 are used here.

For per-interface counters, when dealing with wireless access point (AP) devices implementing the protocol (and not other devices, including a personal computer), APs make available per-interface counters as well as aggregate subnet counters through the protocol. The per-interface counters allow cross-traffic detection on APs even when the nodes on the network are not running the responder. Examples of available interfaces on a typical AP include the BSSID of a wireless band, in which multi-band APs use separate BSSIDs for each band they support, and the wired Ethernet interface, which is usually connected to a built-in switch.

The aggregate subnet counters on the other hand indicate the amount of traffic entering and leaving the subnet, enabling consideration of the capacity of the uplink in QoS WAN admission decisions. The device does not respond to cross-traffic request for an interface that is connected to a different subnet than the one the request is received on. Moreover, the device does not respond to requests coming from the WAN interface.

In one operational state, a source station broadcasts periodic QosCounterLease frames to the subnet. A responder station that sees this frame will start collecting the relevant IP performance counters for the network interface that it saw the QosCounterLease frame on. The collection process will continue for a predefined time period (more information in the Timing section below) and may be renewed with each subsequent QosCounterLease frame received on the same network interface. Responders follow each QosCounterSnapshot request with an appropriate QosCounterResult reply frame, even if they are not collecting the counters on the specific interface.

For network load control, responder implementations are expected to service at least ten QosCounterSnapshot requests per second. Any requests beyond that may be ignored. Given this restriction and the low turnaround time between a QosCounterSnapshot and the subsequent QosCounterResult, there should be no backlog of QosCounterSnapshot requests.

On receipt of a QosCounterLease frame, the protocol guarantees availability of the historical counter data on the network interface it is received on for at least five minutes from time of receipt. In the absence of a pre-existing history collection process, one should ideally be started within no more than one second from the time the QosCounterLease frame is seen. In the unfortunate event that such a process cannot be started due to lack of resource or some other similar event, the QosCounterLease request is ignored.

With respect to reliability, although the protocol does not guarantee delivery of QosCounterSnapshot and QosCounterResult frames, sequence numbers (i.e. the Identifier field in the Base header) are used in QosCounterSnapshot requests and quoted back in each QosCounterResult response so Mapper stations can match responses to requests. The following table shows which function types are allowed to be sent to the broadcast address, which may have a non-zero sequence number, and does have a non-zero sequence number (where an example sequence number is a 16 bit value, advanced using increment in ones-complement arithmetic; that is, the advance from 0xFFFF to 0x0001 and skip 0x0000):

| Function | Value | Broadcast? | Sequence? |
|---|---|---|---|
| QosCounterSnapshot | 0x08 | No | Required |
| QosCounterResult | 0x09 | No | Required |
| QosCounterLease | 0x0A | Yes | No |

The Base header format is as represented in FIG. 7, which also generally applies to Network Test. The real destination Ethernet address allows querying of per-interface counters in the case of wireless access points. For such devices, this address field may identify the BSSID of a wireless band or if it is a special (e.g., FF:FF:FF:FF:FF:FF) address, the aggregate subnet counters are requested instead. For other devices, this field equals the MAC address of the interface on which it is received. The real source Ethernet address is set by a sender to its own Ethernet address. This field is needed because the source address field of the Ethernet header is rewritten by some network devices and thus may not survive an end-to-end transmission. The sequence number ensures reliability of certain packets in the protocol. While frames in this protocol have a sequence number field, it must be zero in some cases; for function codes 0x07 and 0x08, this field is non-zero.

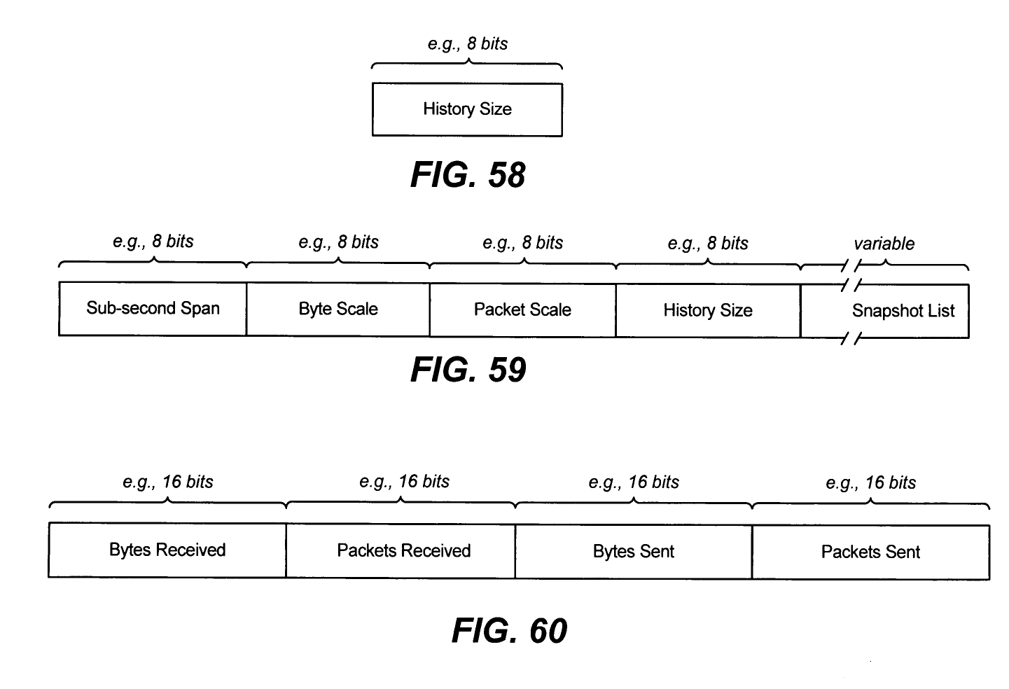

The QosCounterSnapshot header immediately follows the Base header, as represented in the example QosCounterSnapshot Header of FIG. 58. The history size field indicates the maximum number of most recent full 4-tuples to return from the history.

Each QosCounterResult frame will report as many full 4-tuples as requested in the preceding QosCounterSnapshot request. At the time the QosCounterSnapshot request is received, a snapshot of the 4-tuples is also taken, and the time span since the last sampling interval is recorded. This sub-second sample is also returned in the QosCounterResult frame.

A QosCounterResult header immediately follows the Base header, as represented in FIG. 59 as an example QosCounterResult Header. In this header, a sub-second span field indicates the time span (e.g., expressed as 1/256 of a second) since the last sampling interval, taken at the time the QosCounterSnapshot request is received. This field may be zero, in which case the sub-second sample is still present in the snapshot list. The byte scale field indicates the chosen 1-based scaling factor of the byte counters. The valid scaling range is between 1 and 256 kilobytes, inclusive. For example, a value of 0 translates to a scaling factor of 1 kilobyte.

The packet scale field indicates the chosen 1-based scaling factor of the packet counters; one valid scaling range is between 1 and 256 packets, inclusive. For example, a value of 0 translates to a scaling factor of 1 packet.

The history size field indicates the number of full 4-tuples that the responder is able to return. This number does not include the sub-second sample taken at the time the QosCounterSnapshot request is received.

The snapshot list is variable in size, and gives as many 4-tuple snapshots counted by the history size field, plus the sub-second snapshot. In one implementation, each snapshot entry has the example format of FIG. 60. Note that a single QosCounterResult frame may only contain up to a maximum of 184 snapshot entries, including the sub-second snapshot:

$$\begin{matrix}1514 - \\ 14 ( Ethernet header ) - \\ 4 ( Demultiplex header ) - \\ 14 ( Base header ) - \\ 2 ( QosCounterResult header ) \\ 1478 / 8 octets per snapshot entry = 184 snapshot entries .\end{matrix}$$

In other words, the maximum number for the ‘history size’ field is 183, which is over 3 minutes' worth of historical data. Entries in the snapshot list are arranged starting with the oldest 4-tuple snapshot, ending with the sub-second 4-tuple snapshot.

When a device receives the QosCounterLease frame, the leasing period applies to the interfaces on the subnet; in the case of a wireless access point device, it should start collecting history for the aggregate subnet counters as well. It is not required for wireless access points to provide counters for the wired LAN interfaces, (e.g., because such interfaces are not the bottleneck in congestion scenarios). Note that the QosCounterLease frame does not have an upper-level header beyond the Base header itself.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computer network, a method comprising:
communicating data over a protocol, including transmitting a discovery request of a topology type of service from a computing node to a plurality of responders, in which the protocol includes a mechanism that identifies a mapper to which responders are associated;
sending commands from the mapper that cause at least some of the responders to collect network topology data; and
receiving, at the mapper, network topology data provided by at least some of the responders.

2. The method of claim 1 wherein the protocol facilitates an enumeration phase, and further comprising, in the enumeration phase, broadcasting from the mapper at least one enumeration request to the responders to request that responders provide a response.

3. The method of claim 2 wherein the enumeration request includes information as to at least some of the responders that have already responded, and for each responder, determining from the information whether the mapper has received a prior response from that responder, and if not, broadcasting a response to the enumeration request.

4. The method of claim 3 wherein the responder determines a time to broadcast the response to the enumeration request.

5. The method of claim 4 wherein the responder determines the time to broadcast the response based upon an estimated number of responders that need to respond to the enumeration request.

6. The method of claim 1 wherein the protocol further includes a quick discovery type of service, and further comprising broadcasting a quick discovery request from a computing node to a plurality of responders, and receiving at the computing node responses to the quick discovery request from at least some responders.

7. The method of claim 1 wherein the protocol further includes a network test type of service, and further comprising transmitting a network test request of the network test type of service to a plurality of responders by which the responders will collect and return network information.

8. A computer readable medium having computer executable instructions, which when executed perform steps, comprising:
processing data at a responder that was received from a network station, the received data arranged in accordance with a protocol to indicate a type of service and a function corresponding to that type of service, the processing of the data including determining whether the type of service corresponds to an enumerator service or a topology discovery type of service, and if so, determining whether the function corresponds to a discover request, and
a) when the function corresponds to a discover request,
i) determining based on one or more return criteria whether to respond to the discover request, and if so, returning a discover response to the discover request, and
ii) determining whether the type of service corresponds to a topology discovery type of service, and if so, determining whether to enter a command state in a discovery session in which the responder waits for discover commands from the network station; and
b) when the function does not correspond to a discover request,
i) determining from the function whether to end the discovery session, and if so, ending the discovery session, and
ii) determining from the function and other state information whether to perform an operation corresponding to a command received from the network station, and if so, performing the command and responding to the station, and if not, responding to the station without performing the command.

9. The computer-readable medium of claim 8 wherein the type of service corresponds to the topology discovery type of service, and further comprising, transitioning to an emit state at the responder upon receiving an emit command from the network station.

10. The computer-readable medium of claim 8 wherein the type of service corresponds to the topology discovery type of service, and further comprising, receiving one of the following commands from the network station, the commands comprising, charge, emit or query-related commands.

11. The computer-readable medium of claim 8 wherein the type of service corresponds to the topology discovery type of service, and further comprising, returning one of the following response types from the responder to the network station, the response types comprising, acknowledge, flat, or query-related responses.

12. The computer-readable medium of claim 8 wherein the type of service corresponds to the topology discovery type of service, and wherein determining whether to enter the command state in the discovery session includes further computer-executable instructions comprising, detecting a response frame, and completing a pending session based on the response frame.

13. The computer-readable medium of claim 12 wherein determining whether to respond to the discover request further comprises creating a temporary session if a topology session already exists, and wherein returning a discover response includes further computer-executable instructions comprising clearing a temporary session.

14. The computer-readable medium of claim 8 wherein the type of service does not correspond to an enumerator or topology discovery type of service, and further comprising, determining whether the type of service corresponds to a network test type of service, and if so, determining from the function whether to initialize a network test session to collect network statistics, whether to end an existing network test session, or whether to return collected data corresponding to a request identified via the function.

15. A computer readable medium having stored thereon a data structure, comprising, a service field having a value therein indicative of a type of service that is related to discovering nodes in a network or to a network test type of service, and a function field having a value indicative of a function that relates to the type of service, wherein the fields are filled with their respective values at a station and/or at a responder and communicated by the station and/or the responder as part of a protocol used by the station to discover a responder, or communicated by the station and/or the responder to accomplish network testing.

16. The computer readable medium having stored thereon the data structure of claim 15, wherein the value in the type of service field indicates quick discovery, and wherein the value in the function field corresponds to one of: a discover request from the station, a reset request from the station, or a response to a discover request from the responder.

17. The computer readable medium having stored thereon the data structure of claim 15, wherein the value in the type of service field indicates topology discovery, and wherein the value in the function field corresponds to one of: a discover request from the station, a reset request from the station, a response to a discover request from the responder, an acknowledge from the responder, an emit function from the station, a charge function from the station, a flat function from the responder, a query-related request from the station or a query-related response from the responder.

18. The computer readable medium having stored thereon the data structure of claim 15, wherein the value in the type of service field indicates topology discovery, and wherein the value in the function field corresponds to one of a probe request from the responder or a train request from the responder.

19. The computer readable medium having stored thereon the data structure of claim 15, wherein the value in the type of service field indicates network test, and wherein the value in the function field corresponds to one of: a QoS initialize sink function, a QoS ready function, a QoS probe function, a QoS query function, a QoS query response function, a QoS reset function, a QoS error function, a QoS acknowledge function, a QoS counter snapshot function, a QoS counter result function or a QoS counter lease function.

20. The computer readable medium having stored thereon the data structure of claim 15 further comprising, a version field that contains a value indicative of a version of the protocol.
